(19) United States
(12) Patent Application Publication
(10) Pub. No.: US 2015/0230022 A1
(43) Pub. Date: Aug. 13, 2015

(54) WEARABLE ELECTRONIC SYSTEM

(71) Applicant: Samsung Electronics Co., Ltd., Suwon-si (KR)

(72) Inventors: Ryutaro Sakai, Palo Alto, CA (US); Karen Kaushansky, San Fancisco, CA (US); Magnus Borg, San Francicso, CA (US); Amelia Schladow, San Francicso, CA (US)

(21) Appl. No.: 14/595,894

(22) Filed: Jan. 13, 2015

Related U.S. Application Data
(60) Provisional application No. 61/937,389, filed on Feb. 7, 2014.
(60) Provisional application No. 62/027,127, filed on Jul. 21, 2014.

(51) Int. Cl. H04R 1/10

(52) U.S. Cl. CPC H04R 1/1091; H04R 2499/11

(57) ABSTRACT

A method provides a notification on a wearable audio device. The method includes detecting a physical configuration of the wearable audio device. The physical configuration is determined using information provided by one or more sensors on the wearable audio device. At least one notification routed from a mobile device which is connected with the wearable audio device is provided in a manner corresponding to the determined physical configuration.

### CROSS-REFERENCE TO RELATED APPLICATIONS

This application claims the priority benefit of U.S. Provisional Patent Application Ser. No. 61/937,389, filed Feb. 7, 2014 and U.S. Provisional Patent Application Ser. No. 62/027,127, filed Jul. 21, 2014, both incorporated herein by reference.

### TECHNICAL FIELD

One or more embodiments relate generally to wearable audio devices, and in particular, to configurable wearable devices and services based wearable device configuration.

### BACKGROUND

Personal listening devices, such as headphones, headsets, and ear buds, are used to reproduce sound for users from electronic devices, such as music players, recorders, cell phones, etc. Most personal listening devices simply pass sound from a sound producing electronic device to the speaker portions of the listening device.

### SUMMARY

One or more embodiments relate to a configurable wearable audio device and services based on wearable device configuration. In one embodiment, a method provides a notification on a wearable audio device. The method includes detecting a physical configuration of the wearable audio device. The physical configuration is determined using information provided by one or more sensors on the wearable audio device. At least one notification routed from a mobile device which is connected with the wearable audio device is provided in a manner corresponding to the determined physical configuration.

In another embodiment, a system provides a host device including a manager that is configured for providing at least one notification to a connected wearable audio device in a manner corresponding to a detected physical configuration of the wearable device.

In one embodiment, a non-transitory computer-readable medium having instructions which when executed on a computer perform a method comprising detecting a physical configuration of a wearable audio device. In one embodiment, the physical configuration is determined using information provided by one or more sensors on the wearable audio device. At least one notification routed from a mobile device which is connected with the wearable audio device is provided in a manner corresponding to the determined physical configuration.

These and other features, aspects and advantages of the one or more embodiments will become understood with reference to the following description, appended claims and accompanying figures.

### BRIEF DESCRIPTION OF THE DRAWINGS

FIG. 1 shows a wearable device system for audio communication, according to an embodiment.

FIG. 2A shows an example computing environment or ecosystem, that provides hands free control of an ecosystem of content and devices accessible to a wearable device, according to an embodiment.

FIG. 2B shows a block diagram of an example implementation of an embodiment of the electronic wearable device in conjunction with one or more other devices, such as devices shown in FIG. 2A.

FIG. 3 shows an example architecture for a content manager, according to an embodiment.

FIG. 4 shows an example management process performed by the content manager, according to an embodiment.

FIG. 5 shows example readout configurations and selections, according to an embodiment.

FIG. 6 shows example readout content settings, according to an embodiment.

FIG. 7 shows an example readout process, according to an embodiment.

FIG. 8 shows an example notification framework, according to an embodiment.

FIG. 9 shows example audio notification configuration, according to an embodiment.

FIG. 10 shows example notification process, according to an embodiment.

FIG. 11 shows an example broad voice command interpretation, according to an embodiment.

FIG. 12 shows an example table for multi-device orchestration where specific devices in the ecosystem perform the various actions, according to an embodiment.

FIG. 13 shows an example electronic wearable (audio) device (headset) in-ear and a smart device (active) orchestration configuration, according to an embodiment.

FIG. 14 shows an example electronic wearable device in-ear and a smart device (hidden) orchestration configuration, according to an embodiment.

FIG. 15 shows an example electronic wearable device worn as a necklace and a smart device (active) orchestration configuration, according to an embodiment.

FIG. 16 shows an example electronic wearable device in-ear and another wearable device orchestration configuration, according to an embodiment.

FIG. 17 shows an example electronic wearable device worn as a necklace and another wearable device orchestration configuration, according to an embodiment.

FIG. 18 shows an example electronic wearable device in-ear, a smart device (active) and another wearable device orchestration configuration, according to an embodiment.

FIG. 19 shows an example electronic wearable device in-ear, a smart device (hidden) and another wearable device orchestration configuration, according to an embodiment.

FIG. 20 shows an example electronic wearable device worn as a necklace, a smart device (active) and another wearable device orchestration configuration, according to an embodiment.

FIG. 21 shows an example electronic wearable device worn as a necklace, a smart device (hidden) and another wearable device orchestration configuration, according to an embodiment.

FIG. 22A-B show examples of a smart device (active) and another wearable device orchestration configurations, according to an embodiment.

FIG. 23 shows an example electronic wearable device and smart device (hidden) orchestration configuration, according to an embodiment.

FIG. 24 shows an example of multiple wireless connections between an electronic wearable device, another wearable device and smart device, according to an embodiment.

FIG. 25 shows an example of failover for connected devices, according to an embodiment.

FIG. 26 shows an example of automatic reconnection for multiple electronic devices, according to an embodiment.

FIG. 27 shows an example of screen detection and routing for multiple electronic devices, according to an embodiment.

FIG. 28 shows a process flow for providing contextual personal audio, utilizing information from a contextual information platform or a host device that communicates with an electronic wearable device via a communication link, according to an embodiment.

FIG. 29 shows a process flow for providing contextual personal audio, utilizing a voice recognition module of an electronic wearable device, according to an embodiment.

FIG. 30 shows a process flow for providing infotainment, according to an embodiment.

FIG. 31 shows a process flow for providing requested information, according to an embodiment.

FIG. 32 shows a process flow for providing (proactive) smart alerts, according to an embodiment.

FIG. 33 shows a process flow for providing augmented audio, according to an embodiment.

FIG. 34 shows a process flow for providing device control, according to an embodiment.

FIG. 35 shows a process flow for providing ecosystem device integration, according to an embodiment.

FIGS. 36A-C show example user experience (UX) classifications for an electronic wearable device, according to an embodiment.

FIG. 37 shows example processes for activating UXs with an electronic wearable device, according to an embodiment.

FIG. 38 shows an example architecture for contextual and personalized audio for an electronic wearable device, according to an embodiment.

FIG. 39 shows an example flow to determine context detection (first time) for an electronic wearable device, according to an embodiment.

FIG. 40 shows an example flow for interactive audio playback for an electronic wearable device, according to an embodiment.

FIG. 41 shows an example process for content gathering for a morning readout, according to an embodiment.

FIG. 42 shows an example process to determine context detection (not the first time) for an electronic wearable device, according to an embodiment.

FIG. 43 shows an example process for audio menu/interactive audio playback for an electronic wearable device, according to an embodiment.

FIG. 44 is a high level block diagram showing a computing system comprising a computer system useful for implementing an embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate to a configurable wearable audio device and services based on wearable audio device configuration. In one embodiment, a method provides a notification on a wearable audio device. The method includes detecting a physical configuration of the wearable audio device. The physical configuration may be determined using information provided by one or more sensors on the wearable audio device. At least one notification routed from a mobile device which is connected with the wearable audio device is provided in a manner corresponding to the determined physical configuration.

One or more embodiments provide managed services based on detected wearable configuration information and other context. The services may include readouts of important information, notifications, and enhanced voice commands. Other features may include multi-device coordination/intelligent routing, information aggregation, and intelligent notification population on one or more devices or devices that are in focused use by a user (i.e., reading a screen display, listening to a device, manipulating a display on a screen, etc.). One embodiment provides for device state detection though sensors (e.g., light sensor, touch sensor, movement sensor, location sensor, etc.), which may assist in controlling various modes of device usage. One embodiment provides for screen detection-smart device routing to a current device in use. One or more embodiments provide for multi-service shuffle or for aggregation to facilitate action (e.g., across multiple applications). Intelligent population of notifications received on a display or through audio (which may be limited to useful notifications) and intelligent management of information (e.g., interested news, weather, calendar events, traffic, etc.) is provided and may be limited to a device in focused use.

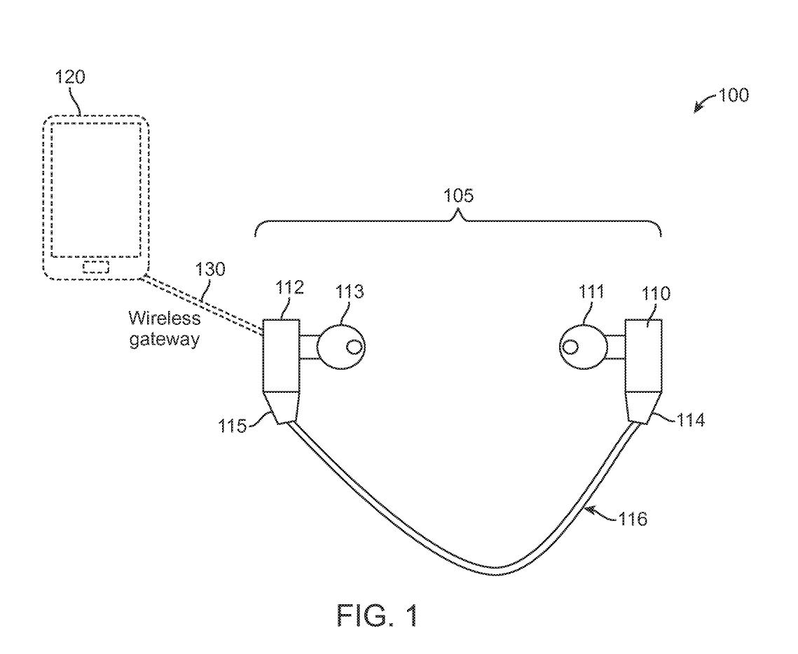

FIG. 1 shows a wearable device system 100 for audio communication, according to an embodiment. In one embodiment, the wearable device 105 includes audio output devices such as ear buds 111 and 113, a swappable cord (or cable) 116 therebetween, at least one battery coupled with an audio module 110, a controller module coupled with the audio module 110 and/or the audio module 112 that controls the audio module 110 and/or the audio module 112 with, for example, controls including audio controls (e.g., buttons, touch interfaces, microphone (e.g., using voice recognition), motion sensing, etc.). In one embodiment, the controls are placed near the front of the cord or cable when worn by a user as a necklace for easy and comfortable access. In another example, the controls are positioned on either or both audio modules 110 and 112. The ear buds 111 and 113 may be attached to the swappable cord 116 through a data connection, (e.g., micro USB, or any other suitable connectivity). In one example, the audio module 110 is connected with a connector 114 (e.g., male micro USB, female micro USB, any other suitable connectors, etc.) and the audio module 112 is connected with a connector 115 (e.g., female micro USB, male micro USB, etc.). In one example, the wearable device 105 may communicate with an electronic host device 120 (e.g., a smart phone, a tablet device, a computing device, an appliance, a wearable device (e.g., a wrist or pendant device), a vehicle, etc.) using a communication medium 130, such as a wireless gateway (e.g., Bluetooth®, etc.). In one embodiment, the wearable device 105 is wearable by a user for listening to audio through one or both of the ear buds 111 and 113.

In one embodiment, the cord or cable 116 may include a cable running through the cord or cable for communication between the audio modules 110 and 112. In one embodiment, the cord or cable 116 may include material overmolded of other soft material (e.g., foam, gel, plastic, other molded material, etc.) for wearable comfort. In one example, the cord or cable 116 may be shaped for comfortable fit when placed against a user's neck. In one embodiment, the cord or cable 116 is designed based on specific uses, such as water resistant or waterproof for watersport use, includes additional padding or material for jogging or sports/activities that would cause the cable or cord 116 to move when the wearable device 105 is in use (e.g., ear buds deployed in a user's ear, worn as a necklace and audio modules 110 and 112 are powered on, in stand-by or operational, etc.). In one embodiment, the cord or cable 116 may include shape-memory alloy or superelastic (or pseudoelastic) material, such as nitinol.

In one embodiment, the wearable device 105 has a weight that is ergonomically distributed between the cable or cord 116 and the ear buds 111 and 113 when worn by a user (either as a necklace, worn in one ear, or worn in both ears).

In one example, the audio module 110 may include a battery (e.g., rechargeable battery, replaceable battery, etc.), indicator LED(s), voice activation button (e.g., digital assistant activation, voice command acceptance trigger, etc.) or touch activated device (e.g., resistive digitizer, touchscreen button, capacitive area or button, etc.), power button or touch activated device, and an audio driver. In one example, the audio module 110 may include a capacitive area or button and resistive digitizer, which may be programmable to serve as controls (e.g., volume, power, microphone control, mute, directional control (forward/back), etc.).

In one example, the cord or cable 116 may include one or more haptic elements including a haptic motor for haptic notifications (e.g., low battery warning, incoming messages (e.g., voicemail or text message), incoming calls, specific caller, timer notifications, distance notification, etc.). In one example, the haptic element(s) may be located behind the neck when the wearable device 105 is worn by a user, spread out around the cable or cord 116, or a single haptic element placed in a desired or configurable location on the wearable device 105.

In one example, the audio module 112 may include a controller module, connection module, volume buttons or touch sensitive controls, play button or touch control, a Hall-effect sensor, one or more microphones, and an audio driver. In one example, the audio modules 110 and 112 may include other sensors, such as a motion sensor, pressure sensor, touch sensor, temperature sensor, barometric sensor, biometric sensor, gyroscopic sensor, global positioning system (GPS) sensor or module, light sensor, etc.

In one example, the connection module of one audio module (e.g., audio module 112) may comprise a wireless antenna (e.g., a BLUETOOTH® antenna, Wi-Fi antenna, cellular antenna, etc.) to wirelessly connect to a host device 120. Other components may include a controller module, physical buttons (configured to control volume, play music, etc.), transducers (such as a Hall-effect sensor), microphone, or audio driver. The other audio module (e.g., audio module 110) with ear bud 111 may comprise a battery for powering the wearable device 105, along with one or more indicator LEDs, physical buttons (configured to be a power button, or virtual assistant activation, or an audio driver.

In one example, the ear buds 111 and 113 may have any type of configurations for in ear placement, over ear loops or flange, assorted sizes and materials (e.g., silicon, elastomer, foam, etc.). In one embodiment, the material of the inner ear portion of the ear bud 111 and ear bud 113 may be sized for noise cancellation along with electronic noise cancellation of the audio module 112.

In one example, the audio module 110 may include a rechargeable battery and ear bud 111 connected for charging for a wearable device 105 for audio communication.

In one example the audio module 110 with ear bud 111 may include a magnet (or one or more magnetic elements) for mating with an audio module 112 with ear bud 113 and another magnet for the wearable device 105 for audio communication. In one example, the audio modules 110 and 112 include magnets for magnetically attracting one another for mating the audio modules 110, 112, ear buds 111, 113 and forming a necklace. In one example the wearable device 105 communicates with the host device 120. The user may utilize physical control buttons, touch sensitive areas or provide voice commands to the wearable device 105 for control and use. In one example, the wearable device 105 is wirelessly connected to a host device 120. In one embodiment, the wearable device 105 includes a clip (e.g., a collar clip) for reducing movement when worn by a user (e.g., when jogging, horseback riding, etc.).

In one example, instead of magnetic elements or magnets, other coupling elements may be used, such as removable (or breakaway) locking elements, electronic magnets, a clasp, hook and loop fastening elements, etc.

In one example, the wearable audio modules 110 and 112 with ear buds 111 and 113, respectively, may comprise one or more sensors for the wearable device 105 to detect the configuration of the device (i.e., configuration detection). For example, the sensors may assist the wearable device 105 for determining a state of configuration of the wearable device (e.g., whether an ear bud is in one ear, both ear buds are in respective ears, the wearable device is in a necklace configuration, or the wearable device is not worn by a user).

In one example, each audio module 110 and 112 for an ear bud has an accelerometer which senses a user's motion or audio module and ear bud orientation. In some embodiments the worn audio modules 110 and 112 with ear buds 111 and 113 will be in some level of constant motion or have the cord 116 pointed roughly downwards. Thus, allowing determination of whether one, both or no ear buds 111 and 113 are in use. In other embodiments, the audio modules 110 and 112 and ear buds 111 and 113 may be configured to respond to various gestures, such as double-tap, shake, or other similar gestures or movements that can be registered by the accelerometer.

In one example, each audio module 110 and 112 for an ear bud 111 and 113 comprises two microphones: one microphone that samples the outside environment, and one microphone that samples inside an ear bud. Signals are compared for selecting the best signal and further audio processing. For example, the signal comparison using a microphone differential may register a muffled noise on the microphone inside the ear bud to determine if the ear bud is in use (e.g., in a user's ear). Optionally, the microphones may be used to perform audio processing, such as noise cancellations or “listen” for voice commands. In some embodiments the microphones may be subminiature microphones, but other microphones may be utilized as well.

In one embodiment, each audio module 110 and 112 for an ear bud includes a pressure sensor. In one example, when an ear bud 111, 113 is inserted into an ear or removed from an ear, an event shows up as a pressure spike or valley. The pressure spike or valley may then be used for determining the state of the wearable device.

In one example, each audio module 110, 112 for ear buds 111 and 113 comprises an optical proximity sensor, such that when worn, a steady proximity signal is generated. In one embodiment, the optical proximity sensor may be located within the housing for the ear bud 111 and/or 113, such that when the ear buds are worn, the optical proximity sensor lies against a user's skin. In one example, the optical proximity sensors provide for determination of whether one, both or no ear buds are in use.

In one embodiment, each audio module 110 and 112 for an ear bud includes a housing element that is sensitive to touch (capacitive sensing). For example, each ear bud housing structure may comprise capacitive touch rings near the flexible ear bud portion of ear buds 111 and 113 that is inserted in a user's ear. Such structure may contact or touch a user's skin allowing determination of whether one, both or no ear buds are in use.

In one embodiment, each audio module 110 and 112 for an ear bud has a mechanical conversion interface to hide the ear buds 111 and 113 in a necklace state. For example, the conversion interface may comprise a magnetic snap which activates a limit switch (e.g., using a hinge) depending on whether the ear bud is in an open or closed position allowing determination of whether one, both or no ear buds are in use.

In one example, electronic components are concentrated in the audio module 110 connected with the left ear bud 111 and in the audio module 112 connected with the right ear bud 113. In one example, one or more LEDs may be distributed around a band or cover of the swappable cord 116 for different functions. In one example, the LEDs may be used for informing a user by using light for alerting to received messaging and notifications. For example, different light patterns or colors may be used for different notifications and messaging (e.g., alerting of particular users based on color or pattern, alerting based on type of message, alerting based on urgency, etc.). In another example, the LEDs may be used for providing light for assisting a user to see the wearable device 105 or elements thereof, such as buttons or control areas, instructions or indications on attaching elements, etc. In one example, the LEDs may be used for providing illumination for seeing the surrounding area (e.g., similar as a flash light). In another example, the LEDs may be used for identifying particular users in the dark (e.g., when in a crowd, a particular user may be associated with a particular pattern of lights, colors, etc.).

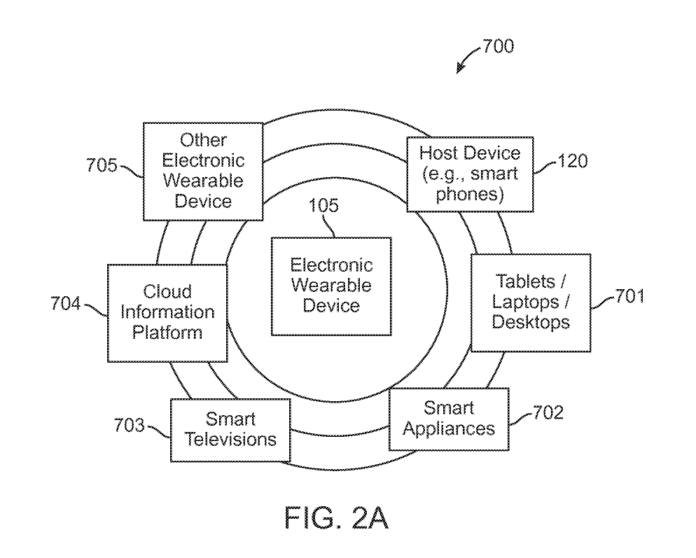

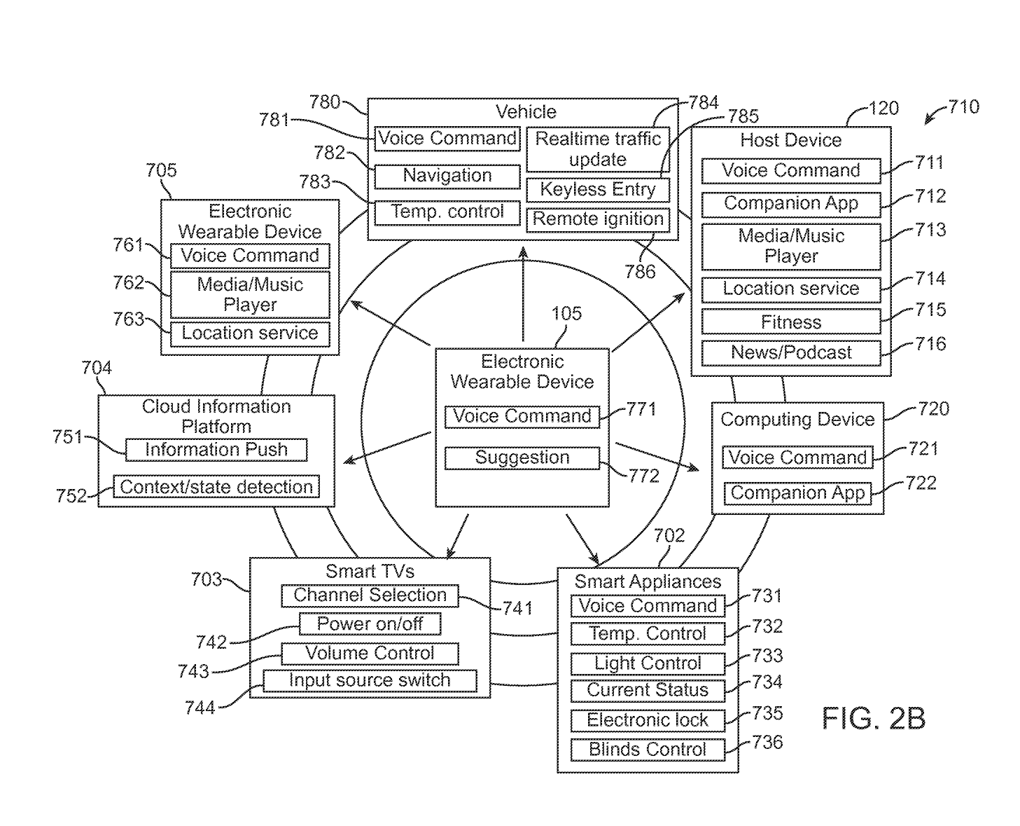

FIG. 2A shows an example computing environment or ecosystem 700, that provides hands free control of an ecosystem of content and devices accessible to a wearable device (e.g., wearable device 105, FIG. 1), according to an embodiment. In one embodiment, the electronic wearable device in conjunction with one or more host devices (e.g., smart phone 120, electronic bracelet 705, smart TV 703, tablet 701, data platform 704 (e.g., cloud information platform), smart appliances 702, automobiles/vehicles 780 (FIG. 2B), etc.) in a computing environment or ecosystem 700, provides hands free control of an ecosystem of content and devices accessible to the wearable device.

In one embodiment, the electronic wearable device may be directly connected with each host device through a communication module (e.g., Bluetooth®, Wi-Fi, Infrared Wireless, Ultra Wideband, Induction wireless, etc.). In another embodiment, the electronic wearable device may interact with other devices through a single host device (e.g., smartphone).

In one embodiment, the connection between the electronic wearable (audio) device and the host device (e.g., a smartphone) may be wireless with the interface between the host device and the rest of the ecosystem occurring over a wired or wireless communication. In one embodiment, available services or processes performed though the electronic wearable device may be performed in several ways. In one embodiment, the processes for the electronic wearable device may be managed by a manager application or module located on a host device. In one embodiment, the processes may be incorporated as extensions of other features of a mobile operating system. Some embodiments may include: the processes solely run/executed from the electronic wearable device; a more robust process run from a host device with a limited version run from the electronic wearable device if there are no host devices to connect to; run solely from a cloud platform, etc. Content may be provided or pulled from various applications or content providers and aggregated before presentation to an end user through a display on a host device, other wearable device (e.g., an electronic wearable bracelet or watch device, a pendant, etc.), or through audio from the electronic wearable device.

FIG. 2B shows a block diagram of an example implementation 710 of an embodiment of the electronic wearable device 105 in conjunction with one or more other devices, such as the host devices shown in FIG. 2A. In one embodiment, a voice assistant (S-voice) application or function may be implemented in the wearable device 105. The voice assistant may also have components implemented in a host device (e.g., smartphone 120, tablet or computing device 720, smart appliance 702, smart TV 703, other electronic wearable devices 705, vehicle 780, etc.) and user commands or queries (e.g., voice commands 771) may be sent or processed in the cloud information platform 704 to perform advanced voice command recognition and determining appropriate actions.

In one embodiment, the electronic wearable 105 device may comprise a suggestion application or function 772. The suggestion application or function 772 may be triggered by a physical button and provide relevant information based on location, time of day, context and activity (e.g., walking, driving, listening, talking, etc.), calendar information, weather, etc. The suggestion application or function 772 may interact with functions in connected host devices to obtain appropriate information. In one embodiment, the suggestion application provides appropriate information based on information learned about the user from context, interactions with others, interaction with the electronic wearable 105 device, personal information, interactions with applications (e.g., obtaining information from social media platforms, calendar applications, email, etc.), location, time of day, etc.

In one embodiment, the companion application (e.g., companion app 712, 722) enables a user to choose services that the user desires. The companion application may also gather content from various sources from smartphone applications and cloud services. For example, for “morning readout,” today's calendar events and weather are gathered prior to being called out so that a playback may be performed by the suggestion application or function 772 on the wearable device 105 immediately/smoothly without any time lag. The companion application may also facilitate other functions, such as controlling a media/music player 762 for media/music player 713, location service applications 714, 763, fitness applications 715, news/podcast applications 716, etc.

In one embodiment, the companion application may be implemented on a host device (e.g., smartphone, tablet, etc.) and may query other devices in the ecosystem. In one example, a smart phone 120 may include functions for voice command 711 (e.g., recognition, interactive assistant, etc.), location services 714, fitness applications 715 and news/podcast 716. The computing device or tablet device 720 may include voice command functionality 721 that operates with the companion app 722.

In one embodiment, the cloud information platform (info platform) 704 comprises a cloud based service platform that may connect with other devices in the ecosystem. The cloud information platform 704 may comprise information push 751 functions to push information to the electronic wearable device 105 or other host devices or assist with context/state detection through a context/state detection function 752.

In one embodiment, an audio manager function may be implemented as a component of the voice assistant function or the companion application 712, 722. The audio manager may be implemented on a host device (e.g., smartphone, tablet, etc.). In one embodiment, the audio manager manages incoming information from other devices in the ecosystem and selectively routes the information to the appropriate device.

In one embodiment the host device may be a smart appliance 702 or the electronic wearable device may interact with a smart appliance through a host device. The smart appliance 702 may comprise functions allowing interaction with the electronic wearable device 105. For example, the functions may allow for execution of voice commands (e.g., voice command function 731) from the electronic wearable device 105, such as temperature control 732 (raise/lower temperature, turn on/off heat/air conditioning/fan, etc.), lighting control 733 (turn on/off lights, dim lights, etc.), provide current status 734 (e.g., time left for a dishwasher/washing machine/dryer load, oven temperature or time left for cooking, refrigerator door status, etc.), electronic lock control 735 (e.g., lock/unlock doors or windows adapted to be wirelessly opened/locked), or blind/shade control 736 (e.g., open/close/adjust blinds in windows adapted for wireless control).

In one embodiment, the electronic wearable device 105 may interact with an automobile or vehicle 780 as a host device or through another host device. The automobile or vehicle 780 may comprise functions to facilitate such an interaction. For example, the functions may allow for voice commands 781 to control navigation 782 (e.g., determining directions, route options, etc.), obtain real-time traffic updates 784, control temperature or climate adjustments 783, provide for keyless entry 785 or remote ignition/starting 786, alarm actions (e.g., horn/lights), emergency tracking via GPS, etc.

In one embodiment the electronic wearable device 105 may interface with a smart TV 703 host device or interact with a smart TV through another host device. The smart TV 703 may comprise functions to facilitate the interaction with the electronic wearable device 105. For example, the functions may allow for voice commands to power on or off the TV 742, control channel selection 741, control volume 743, control the input source 744, control TV applications, communicate with a viewer of the smart TV 703, control recordings, etc.

In one embodiment the electronic wearable device 105 may interface with another electronic wearable device 705 (e.g., a wearable wrist device, pendant, etc.) host device or interact with a wearable device through another host device. Such connections or interactions may occur similarly to the computing environment or ecosystem 700 (FIG. 2A) as described above. The other electronic wearable device 705 may comprise functions to facilitate the interaction with the electronic wearable device 105. For example, the functions may allow for voice commands 761 to control or communicate with the electronic wearable device 105, communicate for operating/controlling a media/music player 762 (e.g., receive audio, play audio, etc.) and location services 763 (e.g., determine location, provide directions, map information, etc.). In one example, the wearable device 105 and/or the wearable device 705 may be directly connected with each host device through a communication module (e.g., Bluetooth®, Wi-Fi, Infrared Wireless, Ultra Wideband, Induction wireless, etc.). In another embodiment, the electronic wearable devices 105/705 may interact with other devices through a single host device (e.g., smartphone).

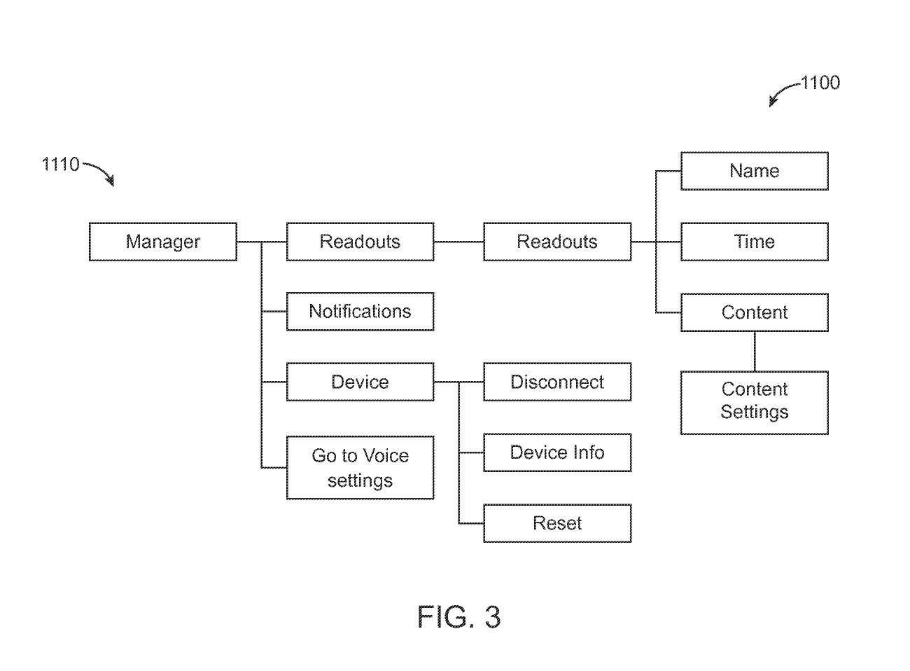

FIG. 3 shows an example architecture 1100 for a content manager application 1110, according to an embodiment. In one embodiment the content manager application 1110 may be used on a host device (e.g., host device 120, FIG. 1). In one embodiment, the content manager application 1110 provides management for readouts (e.g., on host display), notifications (e.g., audio through the electronic wearable device, visual through a host display, vibrations via haptic elements on another wearable device, etc.), management for notifications, device connection management (e.g., wireless or wired), and an interface to voice settings. In one embodiment, the readouts may include name(s), time, content and content settings. The device connection may include disconnecting, reset of a connection, and device information.

The content manager application 1110 may aggregate content from various sources (content on device, other devices owned by a user, a user's personal cloud, third party content providers (from applications, cloud services, hot spots, beacons, etc.), live audio feed, etc.). In one embodiment, the aggregation may be performed through user selection in a device configuration setting. In one embodiment, the content manager application 1110 may evolve or iterate to add content for aggregation. Such inclusion may utilize various machine learning algorithms to determine or predict content that a user may desire to include. The prediction of content may be based on content currently selected as desired, the frequency of content accessed by the user (either through the electronic wearable device, on a host device, or on another device in the ecosystem) in the past or ongoing, suggestions by those having similar interests (e.g., friends, others in social network or circles, family, demographic, etc.), etc. Other examples for suggestions may involve major news or events, emergency information, etc. In one embodiment, the predicted content may be suggested to a user for inclusion through an audio prompt, pop-up notification, automatically included with a feedback request, or through other similar methods that may iterate or learn of user preferences.

In one embodiment, for content aggregation, the content manager application 1110 may limit content to a subset of the compiled or received information. For example, reading out only desired content or providing important notifications. The determination of a subset of information may be manually configured or curated by a user, or intelligently determined through machine learning. In one example, machine learning may gradually populate notifications based on notifications received (either from preloaded or third party applications) and may also learn based on whether the user took action (e.g., responded to the notification, dismissed/cleared, ignored, etc.). In one embodiment, the curation or configuration may be location based (e.g., utilizing GPS location, world region, etc.).

In one embodiment, the content manager application 1110 may control the connection with the electronic wearable device (e.g., the type of connection (wired, wireless, type of wireless) pairing, refreshing/resetting the connection, disconnecting, etc.). In one embodiment, the content manager application 1110 may be able to control certain aspects of the electronic wearable device (e.g., turning device on or off, turning haptic elements on or off, adjusting volume, etc.). The electronic wearable device may have multiple states or configurations (e.g., a necklace mode, mono audio mode, stereo audio mode, etc.). The content manager application 1110 may receive state information from the electronic wearable device sensors to determine the appropriate process or service to provide. For example, whether the device is in necklace mode (e.g., from Hall-effect sensor, determining if magnets are connected, other sensors, etc.) or whether one or both of the ear buds are detected as being in a user ear (e.g., pressure sensor, in use sensor, location sensor, etc.). In one embodiment, the state configuration may also determine whether the device is being worn (e.g., detecting motion from sensors, such as one or more accelerometers).

In one embodiment, the content manager application 1110 may provide voice delivery where the audio information is delivered in a natural sounding way. The information may be performed using scripts, templates, etc. In one embodiment, the content manager application 1110 may utilize an engine to perform grammar or format determination in real-time or near real time. In one embodiment, the content manager application 1110 may utilize the engine to determine the mood of the information, allowing different voice personalities or profiles along with an appropriate tone relating to the information. For example, sport scores may be provided with the inflection of a sports caster or announcer, while a news headline may be presented with a more reserved or conservative inflection. As further examples, sports scores may also be presented in an excited tone, a good news headline may be presented with a happy or cheerful tone, a bad news headline in a serious, somber, or controlled tone, breaking news may be provided in a tone that conveys urgency, etc.

In one embodiment, the content manager application 1110 may also handle various processes or services which may be triggered through voice control or commands, activating a hardware control, etc. The content manager application 1110 may allow for a user to curate or configure content they would like to be included with readouts along with additional settings (such as time period and content), which notifications are considered priority, device connection management, and accessing settings in the operating system or another application.

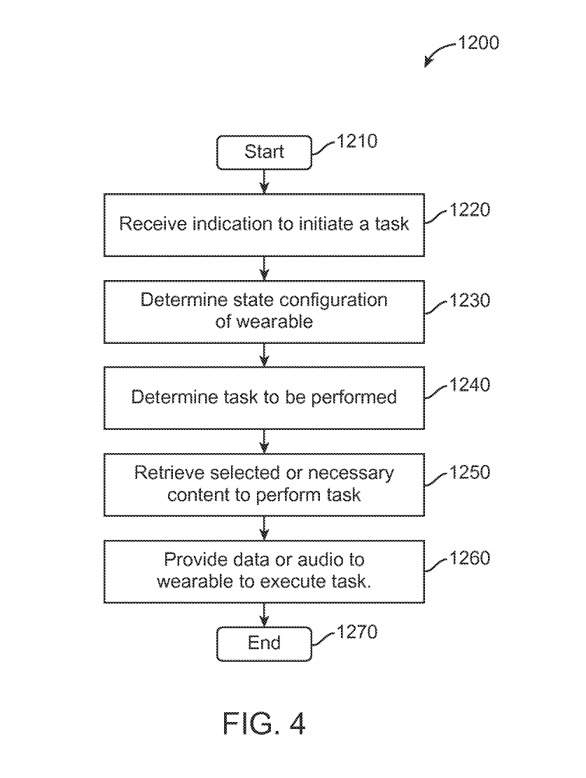

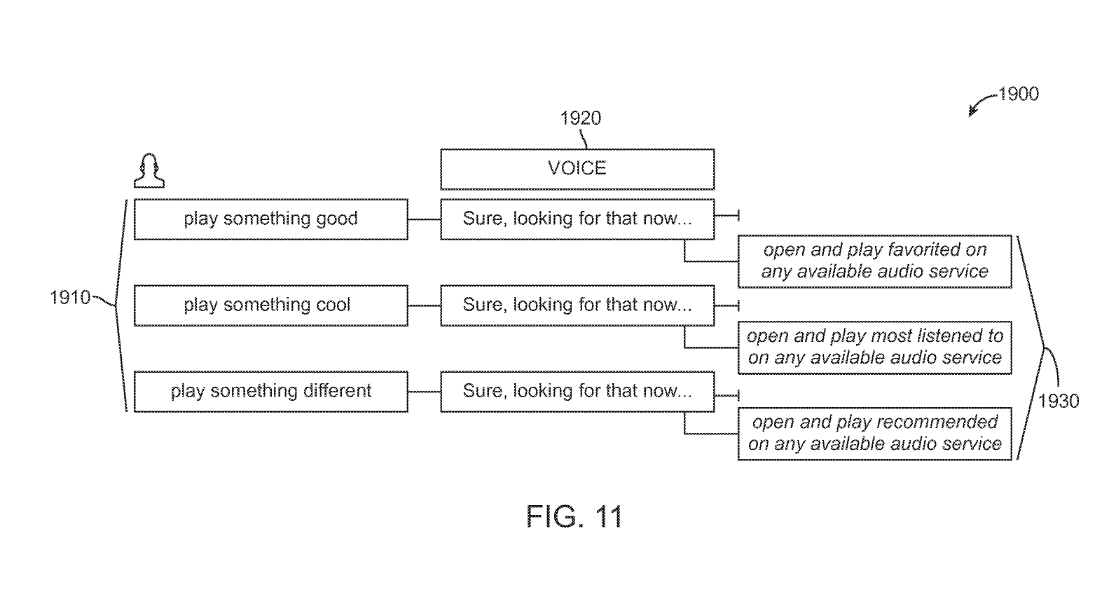

FIG. 4 shows an example management process 1200 performed by the content manager application 1110 (FIG. 11), according to an embodiment. In one embodiment, in block 1210 the process 1200 starts, for example, by powering on a device, accessing settings, providing an audio command, etc. In block 1220 the content manager application 1110 may receive an indication to initiate a task. The indication may be a request from a user through a voice command, hardware trigger (e.g., button press), etc. or from an action triggered by incoming information (e.g., a notification). The task may be to playback relevant information requested (current weather, personal schedule, top news stories, traffic conditions, sports scores, etc.), answer a call, provide a contextual update (e.g., traffic accidents on route, reminders, emergency alerts, weather, etc.).

In block 1230 the content manager application 1110 may determine the state configuration of the electronic wearable device. In one example, this may be performed by receiving information from the sensors and analyzing the provided information to determine the current state (e.g., necklace mode, single in-ear, dual in-ear, not worn, etc.). The wearable device may provide already analyzed state information to the content manager application 1110. A change of device state may be an indication to initiate a task or perform a command. For example, if the electronic wearable device is detected changing from necklace mode to dual in-ear mode, a music application may be launched to begin playing a song, etc. In another example, changing state from in-ear to necklace may pause a task, and if the state is changed back to in-ear within a certain time frame, the task may resume.

In block 1240 the content manager application 1110 may determine the task to be performed. Such determination may be made based on context, such as the time of day, the input indication to perform a task (e.g., command, button press, incoming call/text, etc.), the device state configuration, etc. Examples of such tasks may include readouts, notifications, voice commands, etc.

In block 1250 the content manager application 1110 may retrieve additional information to perform the determined task. For example, the content manager application 1110 may request information from third parties to provide news, sports, weather, etc. If no additional information is necessary, the task may be carried out immediately, as in the case of notifying about an incoming call.

In block 1260 the content manager application 1110 may provide data or audio to the electronic wearable device to execute a task. The content manager application 1110 may process the gathered data and provide information or instructions to the wearable device to carry out the task, such as perform an audio playback. The content manager application 1110 may provide prompts (e.g., audio tone or command prompts), receive voice commands, etc. In block 1270 the process 1200 ends and waits to start again at block 1210.

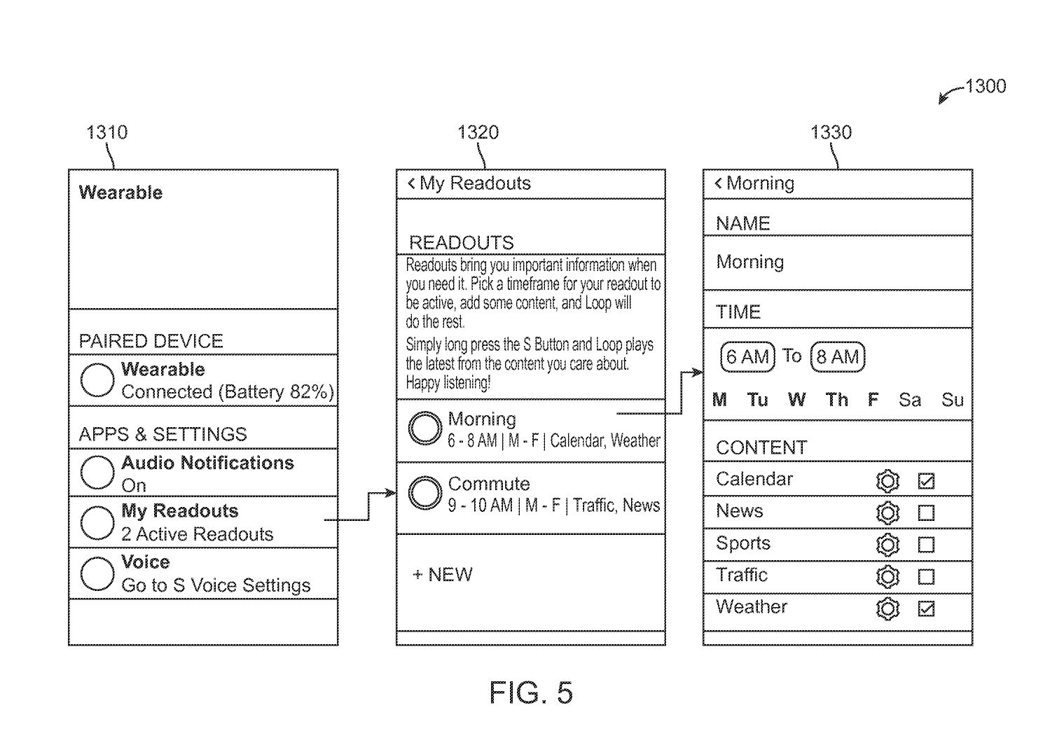

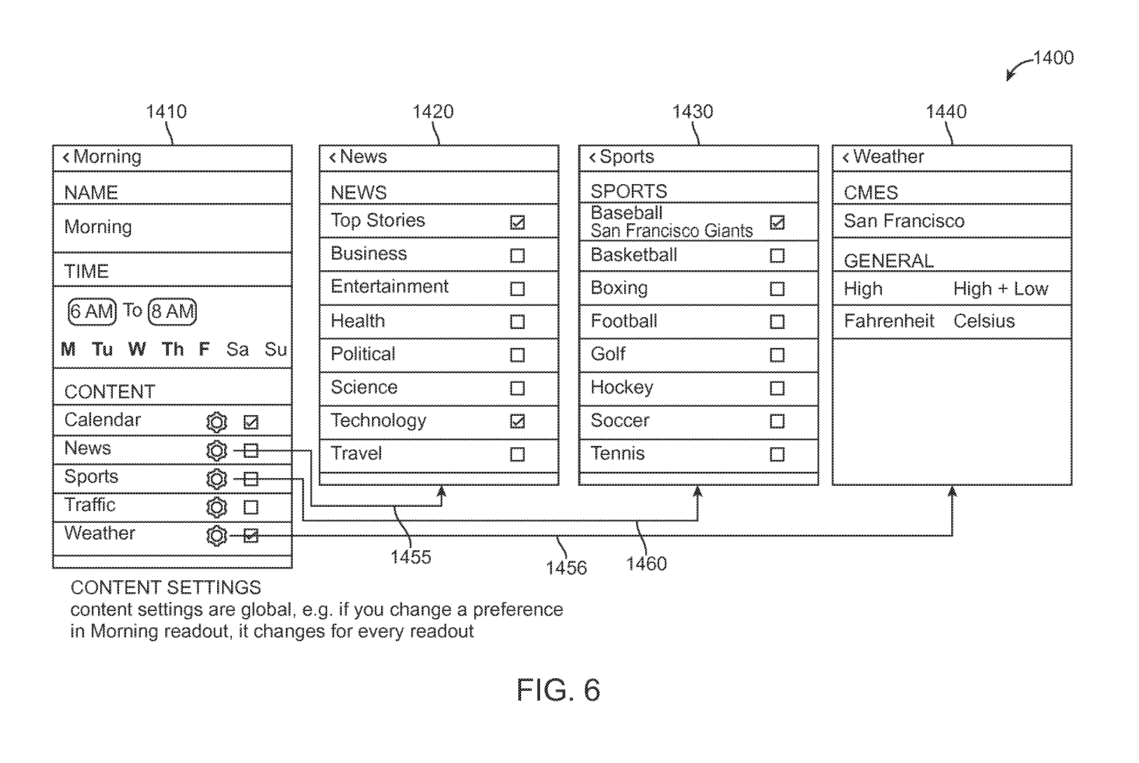

FIG. 5 shows example readout configurations and selections 1300, and FIG. 6 shows example readout content settings 1400, according to an embodiment. In an embodiment, exemplary readout configurations and selections along with example readout content settings may be displayed on the screen of an electronic device 120. In one example, a selection screen 1310 provides selections for settings, including selections for paired device, audio notifications, readouts, voice, etc. Selection screen 1320 includes settings for readouts. In one example, a setting selection on the selection scree 1320 for morning results in screen display 1330 being shown on a device. Settings screen 1410 provides selection for different content and time of day selections. In one example, settings screen 1420 may be shown based on a selection (indicated by arrow 1455) of news on settings screen 1410. In another example, settings screen 1430 may be shown based on a selection (indicated by arrow 1460) of sports on settings screen 1410. In yet another example, settings screen 1440 may be shown based on a selection (indicated by arrow 1456) of weather on settings screen 1410.

In one embodiment, the content manager application 1110 (FIG. 3) may provide a process or service for reading out various content. Content may be provided from the host device, the cloud, other user devices, or a third party content provider. Such content may be designed to be conveyed using scripts, pre-generated templates, or even real-time generation of a readout notification. The scripts, pre-generated templates, real-time generation, etc. may be performed in a manner that emphasizes the most valuable information (such as clearly and concisely conveying the information) and not overwhelming users with excess audio. In one example, the presentation may be performed in a syntax or humanizing playback as if a live person was responding.

In one embodiment, the content may be requested or pulled from the various sources. This content may have been curated by a user to select specific categories. Such curations may be received by the content manager application 1110 through a configuration menu. Examples of content categories that may be curated may include news, calendar (appointments/schedule), weather, traffic, sports, entertainment, etc.

In one example, calendar readouts may provide a playback of a user's upcoming schedule, which may be aggregated from the host device, user's cloud, or other user devices. In one embodiment, the calendar readout may respond differently in various instances based on the aggregated information (e.g., remaining events in the day, no remaining events, no scheduled events, etc.). For example, if there are remaining events, the readout may include the number of events for the day or the number of remaining events, and then provide further additional details such as the time or name of the events. In an example where no events remain, the readout may inform the user there is nothing left on the calendar and provide a preview of tomorrow's scheduled events (e.g., first scheduled item for the next day, or the next item scheduled if the next day is free). In an example where there are no events scheduled for the day, the user may be informed of such, and similarly provide a preview of the next scheduled event on an upcoming day.

In one example, weather readouts may provide varying indications of the weather at a location depending on the time of day. For instance, from 12 AM to 12 PM, the readout may include the forecast for the day and the current temperature. As the day progresses (e.g., from 12 PM to 7 PM) the readout may only include the current temperature. Even later in the day (e.g., 7 PM to 12 AM) the readout may provide the current temperature along with the weather forecast for the upcoming day. In one example, if there are upcoming weather alerts or warnings, they may be included for the duration of the warning.

In another example, news readouts may provide an overview of the news category followed by headlines. The content manager application 1110 may keep track of headlines to ensure there is no repeating of a previously read headline. The number of headlines may be capped to prevent an overflow of information. In one example, the information may be limited solely to the headline and not include additional information such as the author, source, etc. In a situation where no new headlines are available, a readout may indicate such to a user. In one example, important updates may be refreshed or represented indicating there is a change to the story.

In another example, sports readouts may provide different information based on the time in relation to the specific game (e.g., pre-game, during the game, post-game, etc.) The pre-game information may include the dates, times, and teams/competitors competing. There may be a limit of how far in advance schedules may be provided (e.g., a time window of 48 hours, etc.). In one embodiment, the pre-game information may read out multiple scheduled games within a window. During the game the readout may include information such as the score, the current time of the game (e.g., inning, quarter, half, period, etc.). After the game, the sports readout may indicate which team/competitor won and the final score. In one example, in a situation where there is a mixture of in-progress, completed, and future games, the sports readouts may prioritize games that are currently in progress over completed games or future games.

In another example, traffic readouts may provide different information between general traffic or reported accidents/incidents. For example, current traffic conditions may have the readout indicate the degree of traffic on a set route. Multiple routes may be read sequentially or prioritized based on location. In a situation where there is an accident (or multiple accidents), or incident (e.g., construction, debris, cleaning vehicles, etc.) the readout may indicate the accident or incident prior to the degree of traffic on a route. In one example, additional information may be provided, such as how far a backup reaches (e.g., an estimated distance (one mile backup), or to a specific exit, etc.).

One embodiment provides for selection of readout setup configuration for different readouts at different times of the day. For example, a profile may be created for all weekdays from the specific times of 6 AM to 8 AM and include selected content of calendar, and weather. The content may have further settings for what the user would like provided from the content category. For example, the calendar category may include holidays, reminders, appointments, etc. In one example, the weather category may include cities or locations and additional details such as the temperature scale or what granularity of temperature information (e.g., only current temperature, including the high, or including both the high and low). Other embodiments may involve additional contextual aspects such as location. In one example, multiple profiles may be configured to address various times, days, locations, or other aspects, which may result in a user preferring a different readout.

In one embodiment, if there are two readouts which overlap in time, day, location, or other contextual aspects, the manager may intelligently determine (through a process or algorithm) which readout is preferred and play that readout. Such a determination may analyze various aspects such as a user's calendar, current location, readout history (e.g., preferring news over traffic), information from other devices in an ecosystem, or other similar aspects and may utilize a score, weighting, factors, or other similar determinations to predict the preferred profile. For example, if there are two profiles for Monday which overlap at 9 AM, but one has traffic and the other has news. The content manager application 1110 may utilize the GPS location and if the location shows the device (and user) is commuting, the profile with local traffic may be used over news. In one example, other ways to determine profiles may include a user set priority or preference for a profile. Additionally, a command or selection may be received to select a specific readout profile.

In one example, the content manager application 1110 may recognize readouts with overlapping time and provide a prompt to make the appropriate corrections. In another example, the content manager application 1110 may provide the contents from both the readouts for the overlapping period but remove the duplicative categories. For example, if a first readout from 9 AM to 11 AM includes calendar and weather, while a second readout from 10 AM to 12 PM has weather and news, a request for readout between 10 AM to 11 AM plays calendar, weather and news.

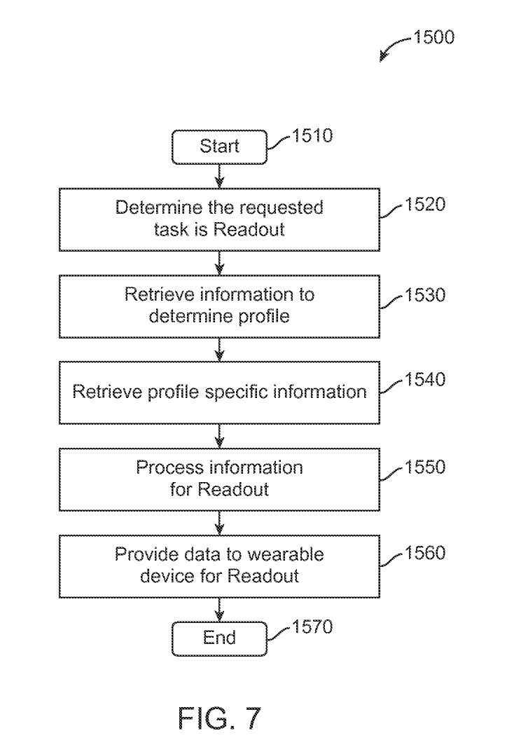

FIG. 7 shows an example readout process 1500, according to an embodiment. Process 1500 may branch off from the process 1200 (FIG. 4) performed by the content manager application 1110. The process 1500 begins in block 1510 (e.g., from powering on a device, starting an app., receiving a voice command, etc.). The process may proceed from the determination of the task in block 1240 for process 1200, or as a separate process 1500 in block 1520 where process 1500 determines the requested task to be performed is readout. In block 1530 the content manager application 1110 may retrieve information to determine the appropriate profile. Such information may include the day of the week, time, command, etc. The manager may perform analysis in the situation where multiple profiles may overlap.

In block 1540 the content manager application 1110 may retrieve specific information or content as needed for the chosen profile (e.g., calendar information, news or sports categories, weather, traffic, etc.). In block 1550 the specific information may be processed and arranged in a format suitable for a readout, allowing for human sounding information. The processing may also reduce the available information to easily digestible segments (e.g., choosing a subset that is most interesting to or preferred by the user). In block 1560 the processed data may be provided to an electronic wearable device for readout. In block 1570 the process 1500 ends or waits to start again at block 1510.

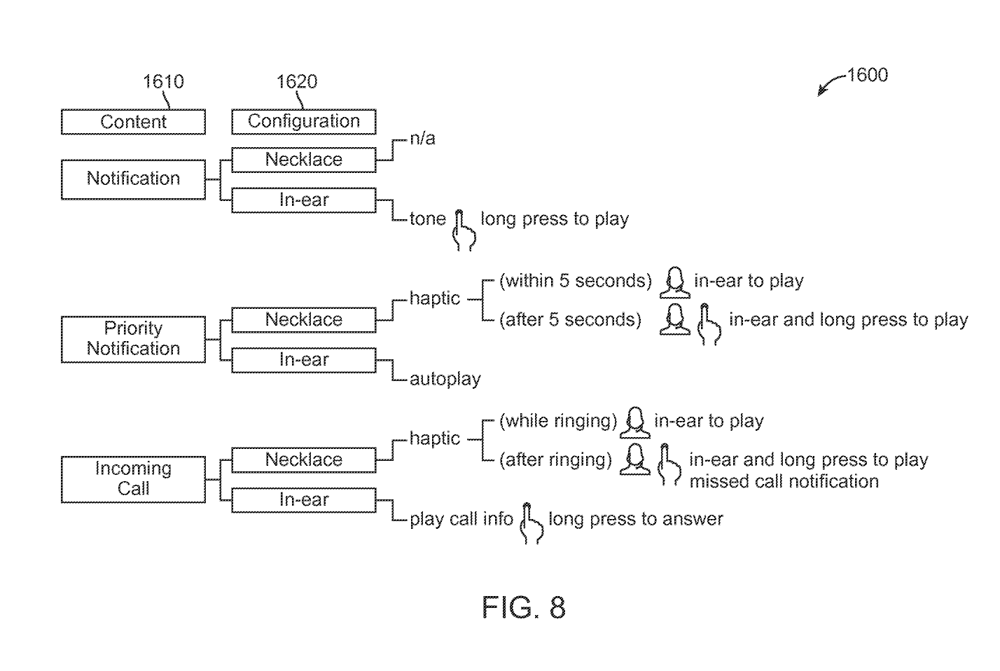

FIG. 8 shows an example notification framework 1600 with different content situations, according to an embodiment. In one embodiment, the notification framework 1600 includes content situations 1610 and configuration 1620 of the electronic wearable device. The content manager application 1110 (FIG. 3) may provide a process or service for audio notifications. Such notifications may be pushed audio for various notifications which have preferences set up in the content manager application 1110. The notifications may be classified in a hierarchy or by priority. The higher priority or more important notifications may be automatically read. Lower priority notifications or normal notifications may be opted into after a user is provided with a prompt for a command. Such a prompt may be a tone and the received command may be registering a hard button press.

In one example, missed notifications may be available as audio for a limited time window/frame. Such a window/frame may be user-configured or a preset time (e.g., 60 minutes). Missed notifications beyond the time window/frame may still be accessible in other forms on other devices. In one example, the content situations 1610 may be regular notifications, priority notifications, and incoming calls. Other content situations may be included such as emergency alerts, etc.

In one example, in a situation with regular notifications, these notifications may include incoming information that a user has opted to receive as an audio notification (e.g., third party notifications from applications, SMS, email, etc.). The state of configuration of the electronic wearable device may determine the subsequent action taken on the information. For example, if the electronic wearable device is in a necklace configuration, no additional action is taken. The notifications may still be accessible and unread on other devices (e.g., a smartphone, another wearable device, etc.). In one example, if a user changes configuration within a limited time window, the audio notification may be available and triggered via a prompt. If the state of configuration is determined to be an in-ear mode, a prompt for action may occur prior to playing the notification.

In an example where the content is a priority notification, based on the state of configuration different actions may be performed. In one example, if the configuration is determined to be in-ear, the priority notification may automatically begin playing without receiving any responses form a user. If the state is determined to be a necklace configuration, an indication to provide a haptic response (e.g., vibration notification) may be given, and depending on whether a state change is detected within a preset time window/frame (e.g., within 5-10 seconds), the priority notification may automatically play or may require further confirmation to play (e.g., after 5-10 seconds, receiving hardware button press), or an audio indication (e.g., a tone) may be audible only to the user when in necklace mode.

In one example, for an incoming call, depending on the electronic wearable device state of configuration, different actions may be performed. If the detected state is in-ear, the caller information may be provided and await a response (button press, voice command, etc.) before the call is answered. If the detected state is in a necklace mode, a haptic notification may be provided (optionally a ringtone may sound). If the device state is registered as changing from necklace to in-ear while the haptic notification or ringing is occurring, the call may be answered. If the state change is detected after, further received input may be required to play a missed call notification.

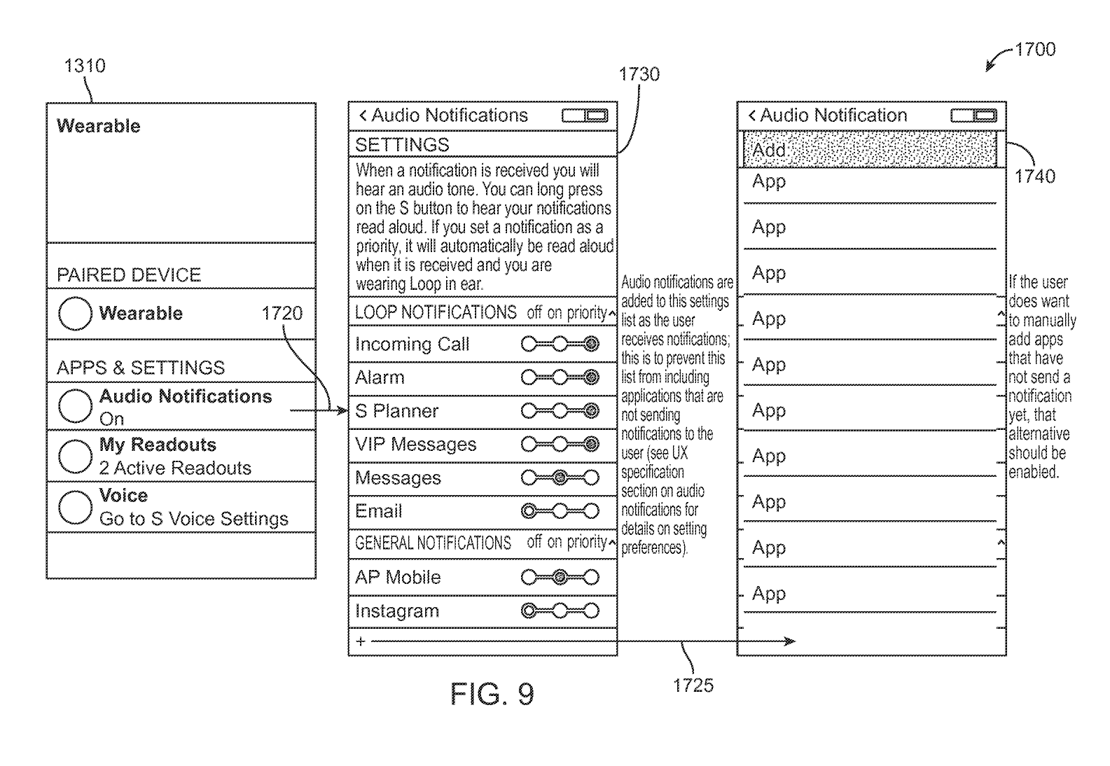

FIG. 9 shows example audio notification configuration 1700, according to an embodiment. The configuration may allow a user to curate and set desired notifications and also the priority level. In one example, the user may add third party applications notifications that may contain desired notifications. In one embodiment, the screen display 1310 provides a selection for audio notifications. In one example, selecting audio notifications (indicated by arrow 1720) results in screen display 1730. In one example, a selection of additional applications or services (indicated by arrow 1725) results in screen display 1740 that provides selection for the additional application or service.

In one example, the content manager application 1110 (FIG. 3) may be configured to progressively populate audio notifications with third party applications based on received notifications from applications over time. For example, the content manager application 1110 may initially start with no third party applications as shown in the screen display 1740. Over time, as third party applications or services are added and notifications are received, the content manager application 1110 may populate the list with third party applications or services that provide alerts (e.g., a map application, a messaging application, a social network application, a public service notification, etc.). Further, the content manager application 1110 may utilize machine learning to determine a recommended priority level. For example, a social network application where each notification is checked within a short time of receipt may be set as a priority notification while a messaging application that is infrequently checked may merely be set as a regular notification. In one example, a manager may also use machine learning to recommend adjustments of priority levels if a user behavior changes over a period of time. For example, if a user stops checking or begins ignoring notifications from a specific application, the manager may either recommend or automatically set the notifications to off.

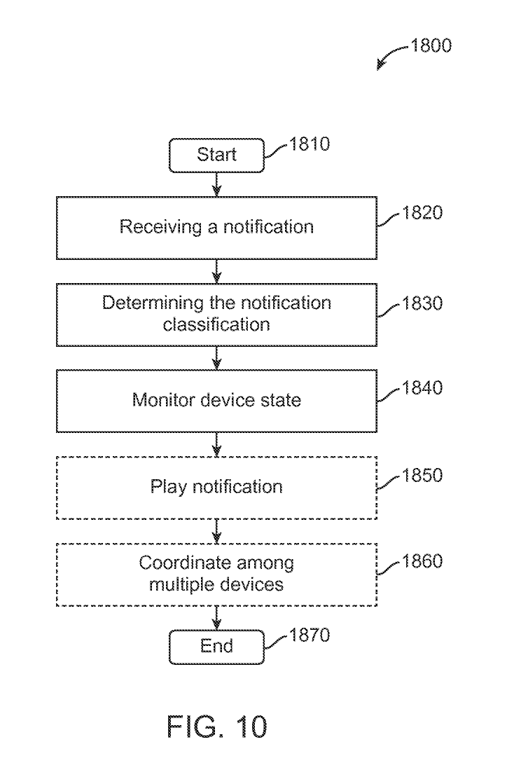

FIG. 10 shows an example notification process 1800, according to an embodiment. In one embodiment, process 1800 may start in block 1810 (e.g., by turning on a device, starting an application, receiving a voice command or button press, etc.). The notification process 1800 for the content manager application 1110 may branch off from the process 1200 shown in FIG. 4. In block 1820 the content manager application 1110 may receive a notification. The notification may be pushed from a third party, user cloud, or other on device application (e.g., email, SMS, calendar reminder, incoming call, etc.). In block 1830 the content manager application 1110 may determine the notification classification (e.g., regular, priority, etc.) based on preset profiles. The content manager application 1110 may intelligently determine using learning algorithms and suggest priority based on frequency, history, interest, or other context.

In block 1840 the content manager application 1110 may receive information allowing it to monitor device state and detect any state changes. In block 1850, the content manager application 1110 may optionally determine whether various actions such as playing the notification is to be performed. In block 1860, the content manager application 1110 may optionally coordinate among one or more connected devices. For example, an incoming notification may also provide an indication on a screen of a connected device (e.g., smartphone or another wearable device). The notifications may be sent to all connected devices.

In one example, the routing may be performed based on screen detection or other received sensor information of the device determined to be the most appropriate (as described further below). The screen notification may be performed on the most appropriate device (e.g., device of current user focus or activity). In one example, combinations of readout and audio notifications may occur with priority being placed on one feature over another (e.g., notifications played before Readout, etc.). In one example, in block 1870 the process 1800 ends and waits to start again at block 1810.

FIG. 11 shows an example architecture 1900 for natural voice command interpretation, according to an embodiment. In one embodiment, exemplary received user voice commands 1910 are responded to with Voice 1920 examples audio responses and example actions 1930 can be taken. In one example, the content manager application 1110 may provide universal controls allowing control of various media services through the interpretation of commands. The commands may be provided for response to all applicable applications (e.g., multi-service media shuffle) and an appropriate response is chosen. The selection of a response may be performed by random choice, first response (e.g., lowest latency, etc.), or through the determination of a score based on various factors (including frequency, location, other contextual factors, etc.). For example, the manager may interpret a command such as “Play me something good” as a more specific command(s) and query several third party music or media applications. In one example, the manager may interpret the term “something good” as songs a user has marked as a favorite song. The manager may then select an appropriate response, and launch a frequently used application to play a favorite song. In one embodiment, the electronic wearable device may serve as a superior input interface for voice commands. The content manager application 1110 may facilitate such interaction between devices and support multiple device coordination.

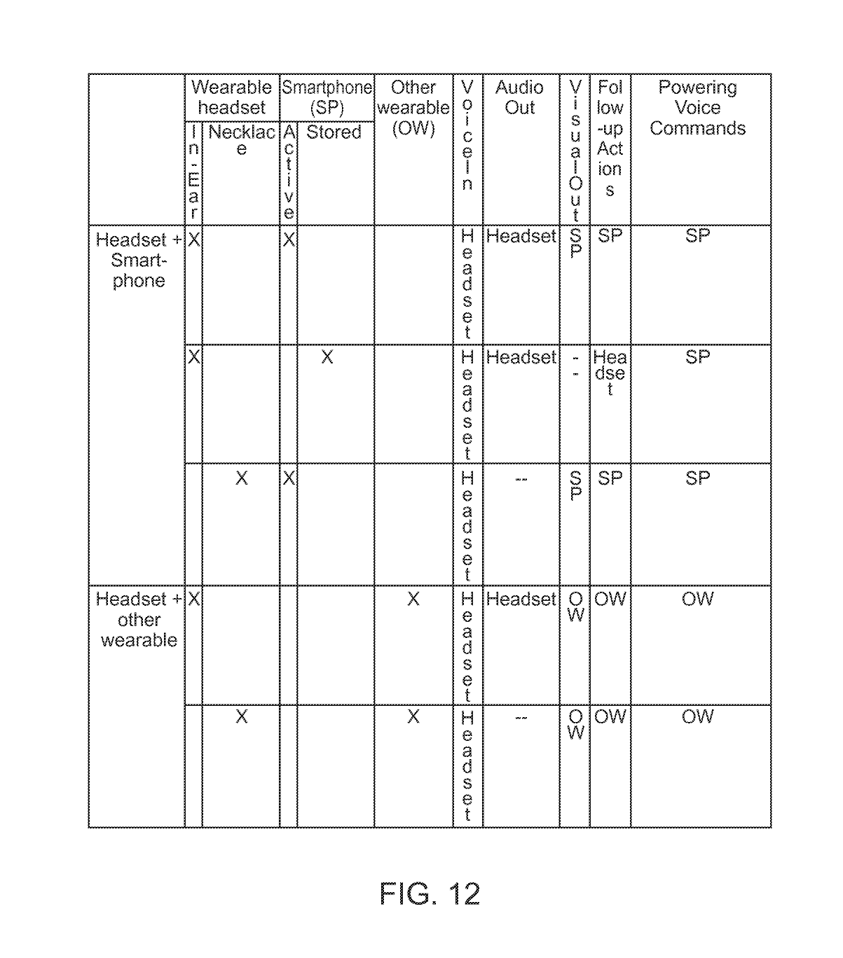

FIG. 12 illustrates a table showing an exemplary embodiment of multi-device orchestration where specific devices in the ecosystem perform the various actions and the device providing the majority of the processing power. The table in FIG. 12 illustrates certain aspects depending on the state of configuration of the electronic wearable (audio) device (in-ear or necklace) and whether the host device (e.g., smartphone) is active or stored/hidden (e.g., in pocket, purse, etc.).

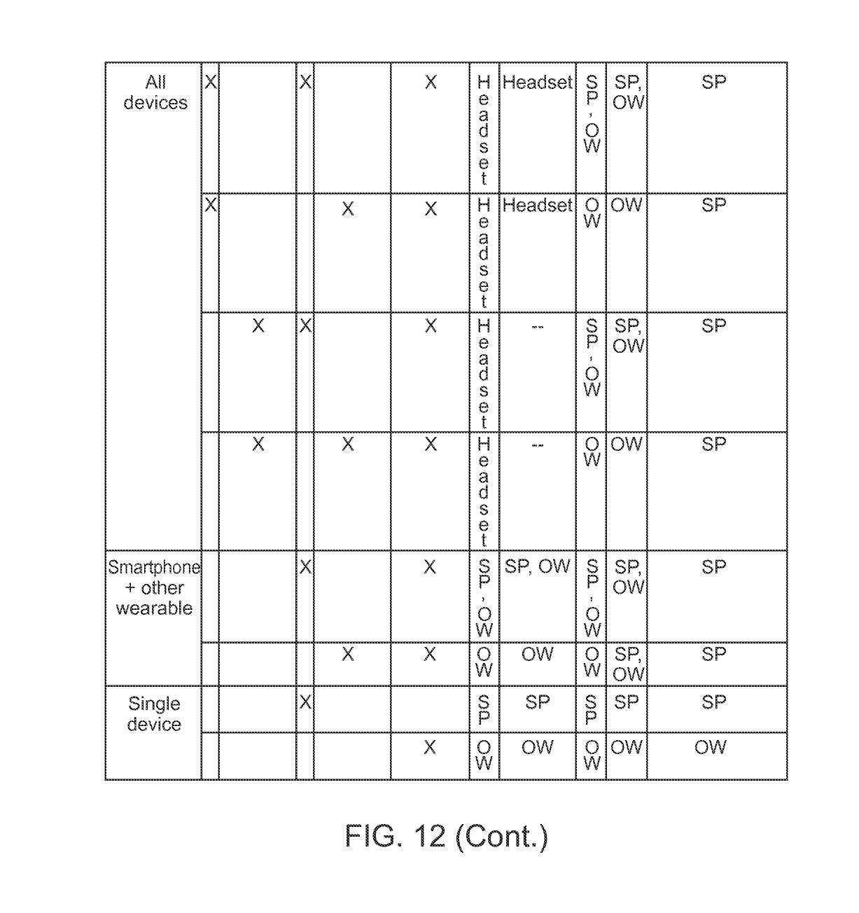

The following FIGS. 13-23 illustrate exemplary configurations as shown in the table of FIG. 12.

FIG. 13 shows an example 2000 electronic (audio) wearable device (headset) 2010 in-ear and a smart device (e.g., smartphone (SP))(in an active state) 2050 orchestration configuration, according to an embodiment. In one embodiment, the electronic wearable device 2010 is used to send a Voice in 2020 signal to the smart device 2050 and receive an audio out 2040 signal from the smart device 2050. In one example, the electronic wearable device 2010 is connected with the smart device 2050 via a wireless connection 2030 (e.g., BLUETOOTH®, Wi-Fi, etc.). In one example, the smart device 2050 shows a visual output on a display based on the voice command in the 2020 signal.

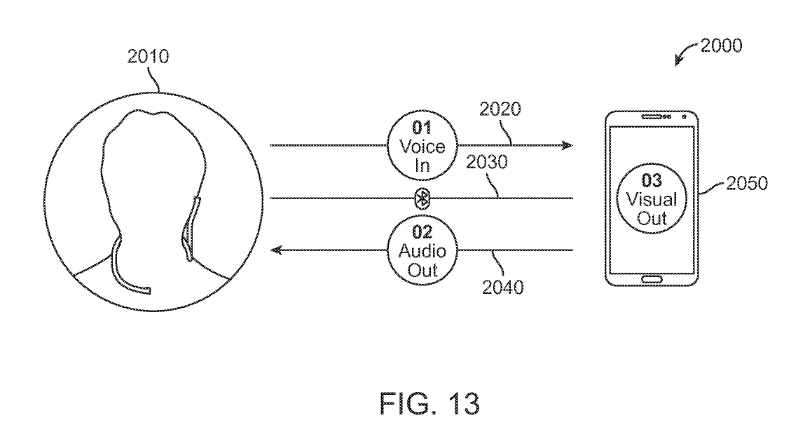

FIG. 14 shows the example 2100 electronic wearable device 2010 in-ear and the smart device (hidden state) 2150 orchestration configuration, according to an embodiment. In one example, the hidden state refers to the smart device being stowed in a pocket, a purse, a backpack, etc. In one example, sensors of the smart device (e.g., ambient light sensors, touch sensors, etc.) determine that the device is in the stowed state. In other examples, the smart device may be stowed in a holder, a glove box, etc. when the user is in a vehicle. In one example, the electronic wearable device 2010 is used to send a voice command in a 2020 signal to the smart device 2150 and receive an audio out 2040 signal from the smart device 2150. In one example, the electronic wearable device 2010 is connected with the smart device 2150 via a wireless connection 2030. In one example, the smart device 2150 does not show a visual output on a display based on the voice command in the 2020 signal.

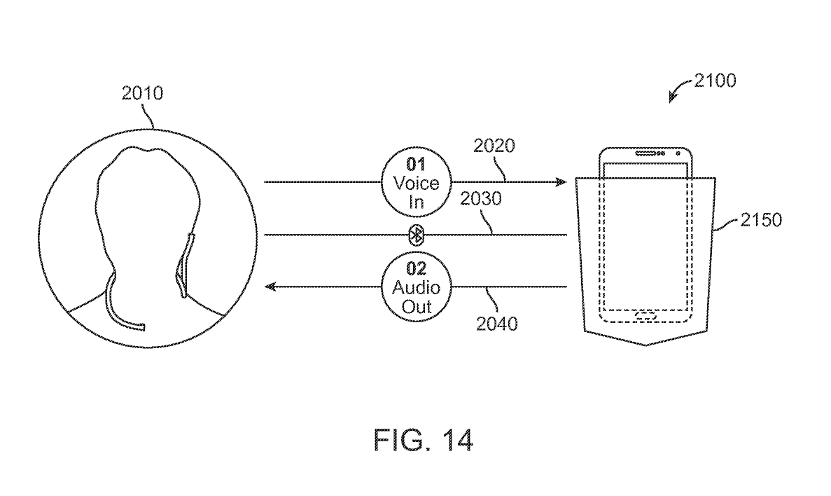

FIG. 15 shows an example 2200 electronic wearable device 2210 worn as a necklace and a smart device (active) 2220 orchestration configuration, according to an embodiment. In one example, the smart device is determined to be in the active state when the sensors (e.g., ambient light sensors, pressure sensors, etc.) determine that the smart device is not in a stowed state. In one embodiment, the electronic wearable device 2210 is used to send a voice command in the 2020 signal to the smart device 2220. In one example, the electronic wearable device 2210 is connected with the smart device 2220 via a wireless connection 2030. In one example, the smart device 2220 shows a visual output on a display based on the voice command in the 2020 signal.

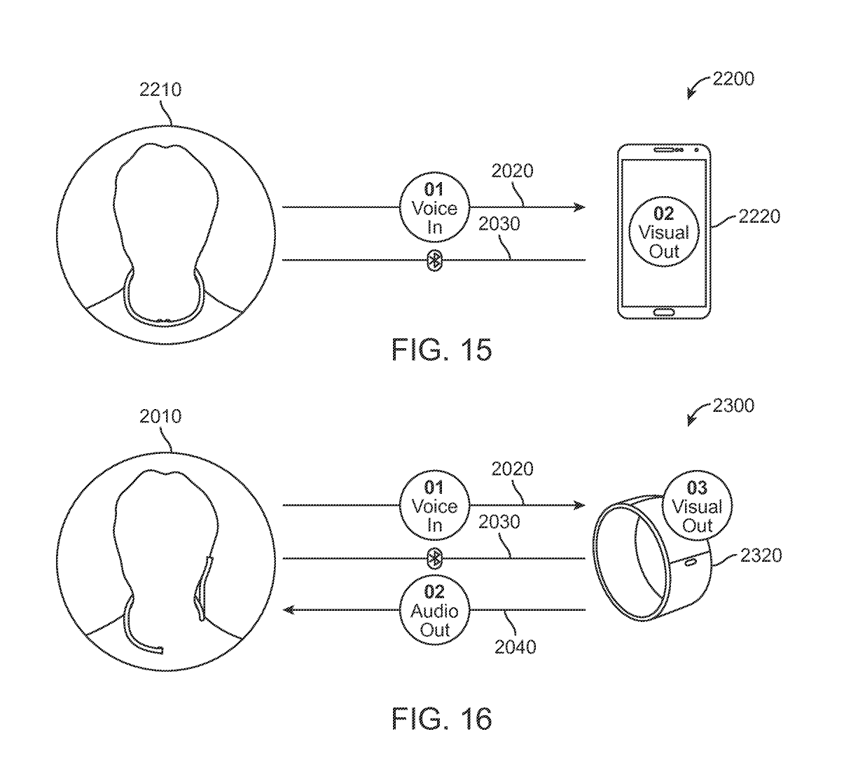

FIG. 16 shows an example 2300 electronic wearable device 2010 (in-ear) and another wearable device 2320 orchestration configuration, according to an embodiment. In one embodiment, the other wearable device 2320 may be a bracelet or smart watch device that includes a visual display, haptic elements, audio, etc. In one example, the electronic wearable device 2010 is used to send a voice command in the 2020 signal to the other wearable device 2320 and receive an audio out 2040 signal from the other wearable device 2320. In one example, the electronic wearable device 2010 is connected with the other wearable device 2320 via a wireless connection 2030. In one example, the other wearable device 2320 shows a visual output on a display based on the voice command in the 2020 signal.

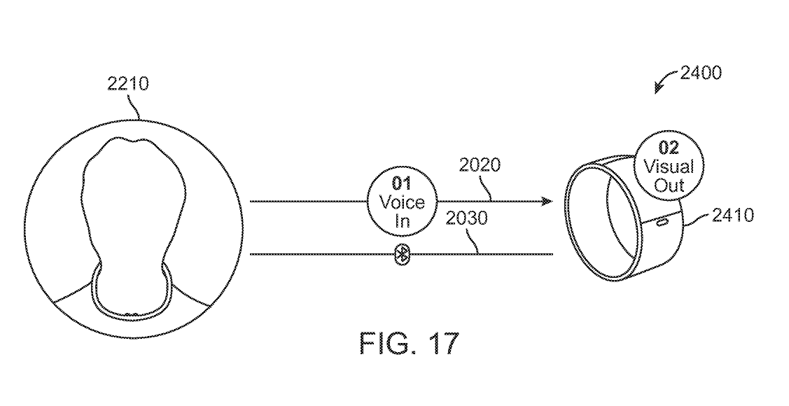

FIG. 17 shows an example 2400 of the electronic wearable device 2210 worn as a necklace and another wearable device 2410 orchestration configuration, according to an embodiment. In one example, the other wearable device 2410 may be a bracelet or smart watch device that includes a visual display, haptic elements, audio, etc. In one example, the electronic wearable device 2210 is used to send a voice command in the 2020 signal to the other wearable device 2410. In one example, the electronic wearable device 2210 is connected with the other wearable device 2410 via a wireless connection 2030. In one example, the other wearable device 2410 shows a visual output on a display based on the voice command in the 2020 signal.

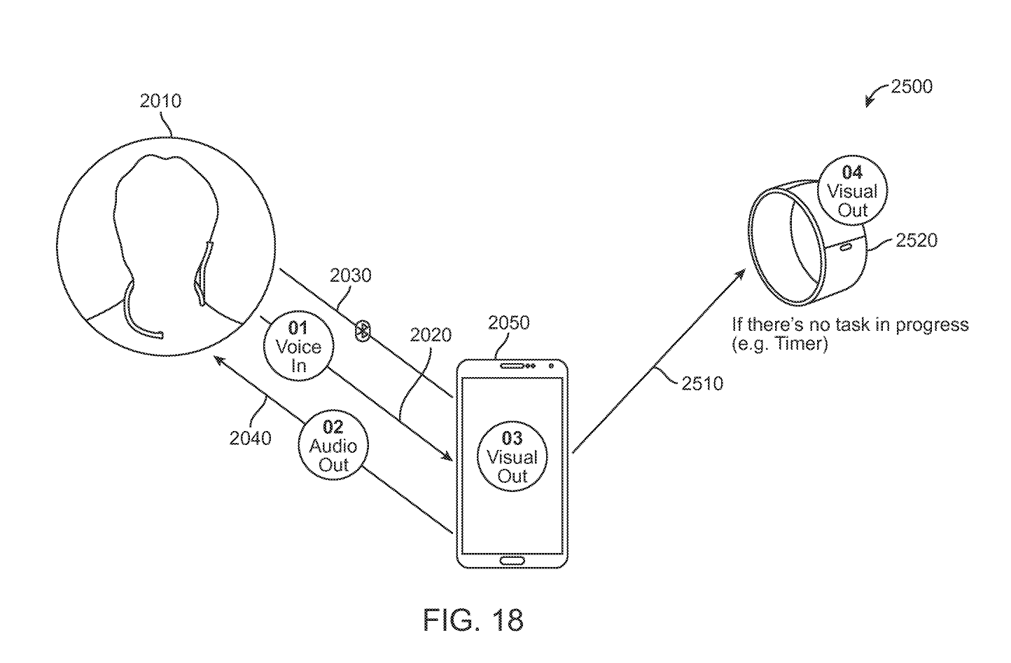

FIG. 18 shows an example 2500 of the electronic wearable device 2010 in-ear, the smart device (active) 2050 and the other wearable device 2520 orchestration configuration, according to an embodiment. In one example, the electronic wearable device 2010 is used to send a voice command in the 2020 signal to the smart device 2050 and receive an audio out 2040 signal from the smart device 2050. In one embodiment, the electronic wearable device 2010 is connected with the smart device 2050 via a wireless connection 2030, and the smart device 2050 is connected to the other wearable device 2520 via a wireless connection 2510. In one embodiment, the smart device 2050 and the other wearable device 2520 (if no other task is in progress) show a visual output on a display based on the voice command in the 2020 signal.

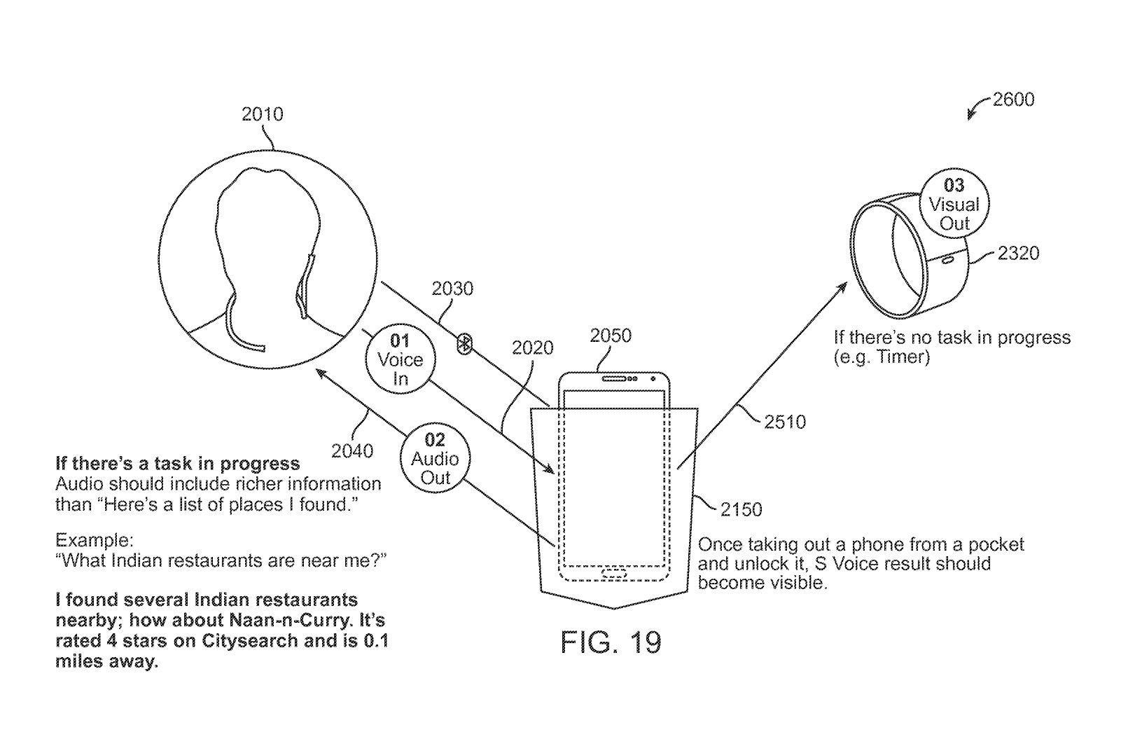

FIG. 19 shows an example 2600 of the electronic wearable device 2010 in-ear, the smart device 2150 (hidden) and the other wearable device 2320 orchestration configuration, according to an embodiment. In one example, the electronic wearable device 2010 is used to send a voice command in the 2020 signal to the smart device 2150 and receive an audio out 2040 signal from the smart device 2150. In one example, the electronic wearable device 2010 is connected with the smart device 2150 via a wireless connection 2030, and the smart device 2150 is connected to the other wearable device 2320 via a wireless connection 2510. In one example, the smart device 2150 does not show a visual output on a display, and the other wearable device 2320 (if no other task is in progress) shows a visual output on a display based on the voice command in the 2020 signal. In one example, if there is not a task in progress on the electronic wearable device 2010, the audio out 2040 may include richer information than if a task is in progress. For example, if there is a task in progress on the electronic wearable device 2010, an example audio out may reply to a voice command in of “what Indian restaurants are near me?” with “here is a list of places I found.” If a task is not in progress, the example audio out may then include “I found several Indian restaurants nearby; how about restaurant A. It's rated 4 stars on XYZ search and is 0.1 miles away.” In one example, once the smart device 2150 is taken out of a pocket and is unlocked (e.g., becomes active), the smart device 2150 may display the voice command results on a display.

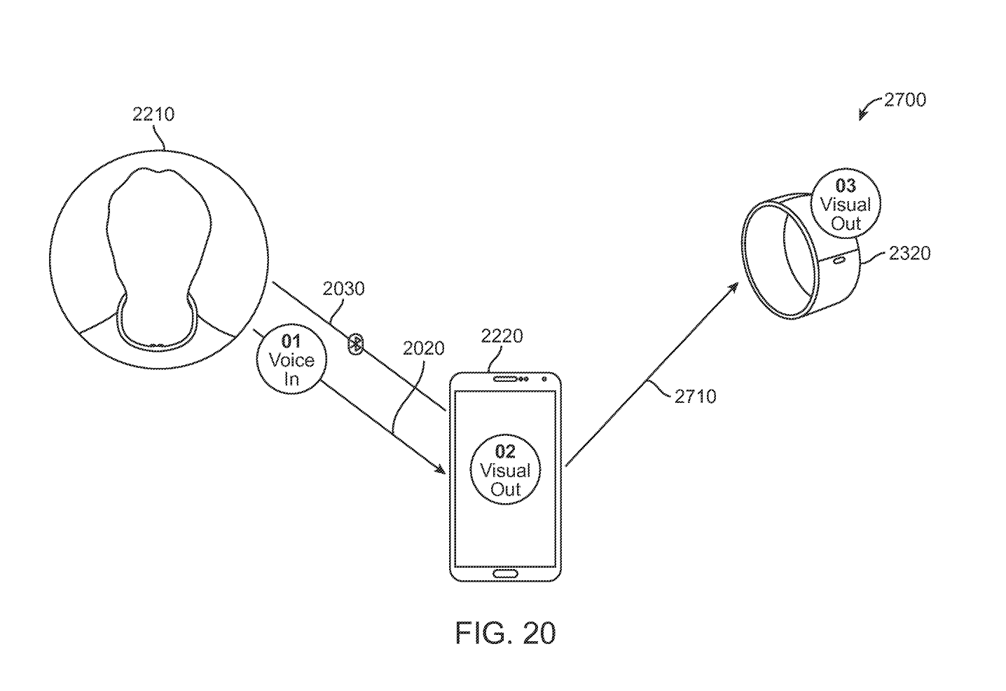

FIG. 20 shows an example 2700 of the electronic wearable device 2210 worn as a necklace, the smart device 2220 (active) and the other wearable device 2320 orchestration configuration, according to an embodiment. In one example, the electronic wearable device 2210 is used to send a voice command in the 2020 signal to the smart device 2220. In one example, the electronic wearable device 2210 is connected with the smart device 2220 via a wireless connection 2030, and the smart device 2220 is connected to the other wearable device 2320 via a wireless connection 2710. In one example, the smart device 2220 and the other wearable device 2320 show a visual output on a display based on the voice command in the 2020 signal.

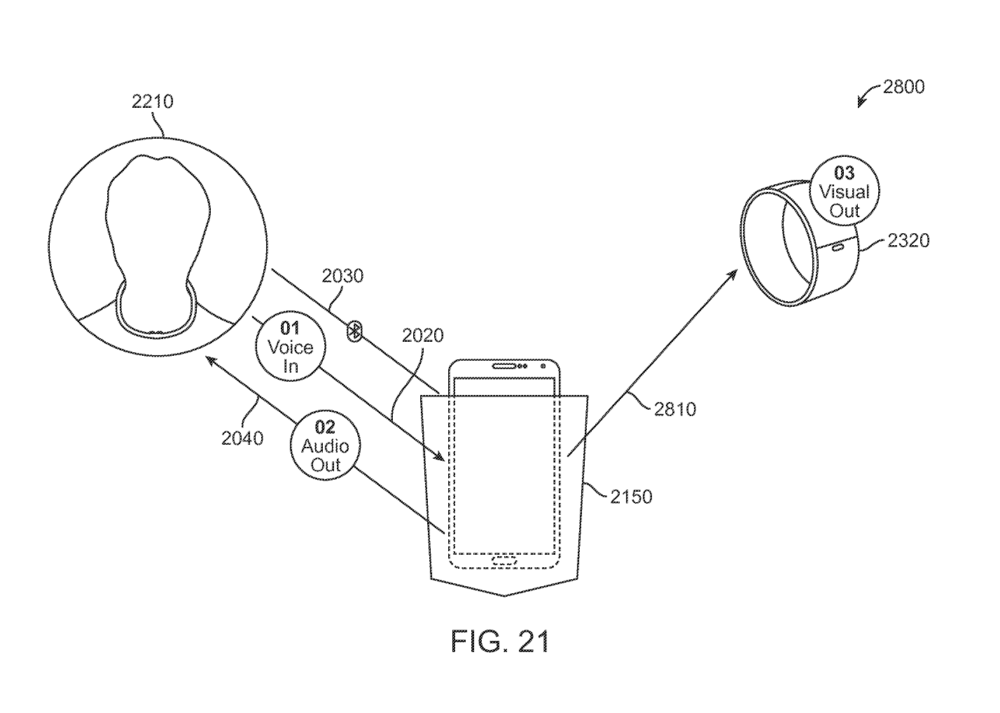

FIG. 21 shows an example 2800 of an electronic wearable device 2210 worn as a necklace, the smart device (hidden) 2150 and the other wearable device 2320 orchestration configuration, according to an embodiment. In one example, the electronic wearable device 2210 is used to send a voice command in the 2020 signal to the smart device 2150 and receive an audio out 2040 signal from the smart device 2150. In one example, the electronic wearable device 2210 is connected with the smart device 2150 via a wireless connection 2030, and the smart device 2150 is connected to the other wearable device 2320 via a wireless connection 2810. In one example, the smart device 2150 does not show a visual output on a display, and the other wearable device 2320 shows a visual output on a display based on the voice command in the 2020 signal.

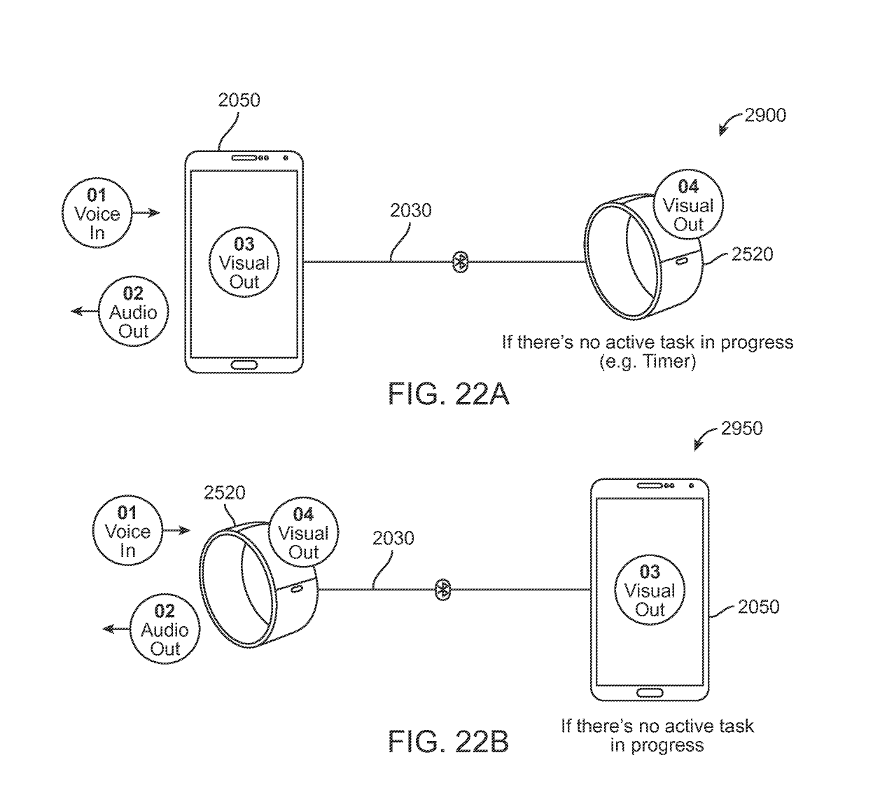

FIGS. 22A-B show examples 2900 and 2950, respectively, of a smart device 2050 (active) and the other wearable device 2520 orchestration configurations, according to an embodiment. In the examples 2900 and 2950, the wireless device 2050 and the other wearable device 2520 are connected with a wireless connection 2030. As shown, depending on the device used for the voice in, audio out and a visual out are sent to the appropriate device.

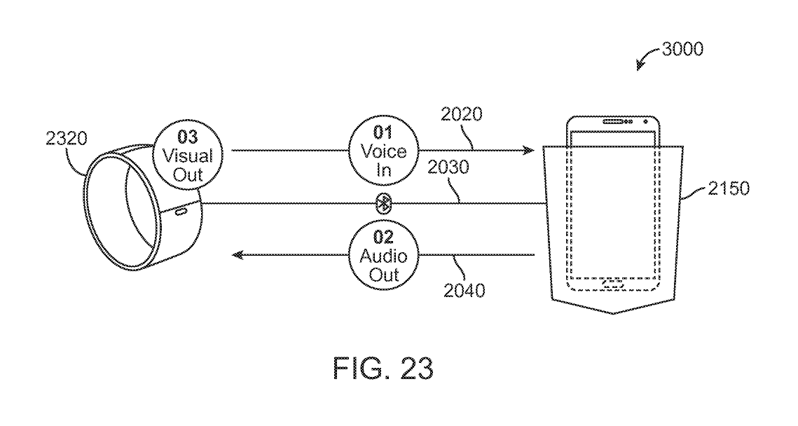

FIG. 23 shows an example 3000 of the other wearable device 2320 and smart device 2150 (hidden) orchestration configuration, according to an embodiment. In one example, the other wearable device 2320 is used to send a voice command in the 2020 signal to the smart device 2150 and receive an audio out 2040 signal from the smart device 2150. In one example, the other wearable device 2320 is connected with the smart device 2150 via a wireless connection 2030. In one example, the other wearable device 2320 shows a visual output on a display.

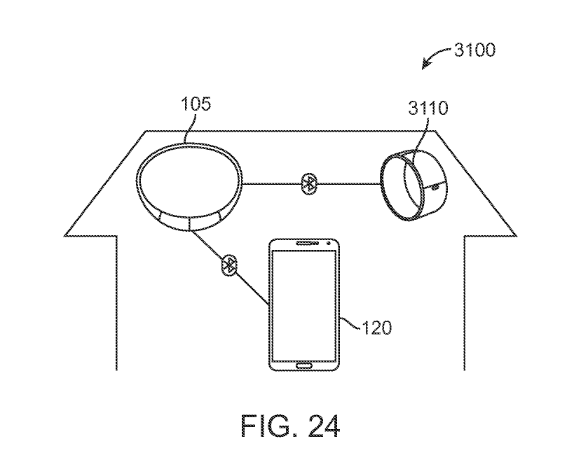

FIGS. 24-26 illustrate embodiments of multiple wireless connections which may be controlled by the content manager application 1110 (FIG. 3). In one example, depending on the processing power of the devices connected and available for receiving a voice command, different levels of a voice assistant are available. In one example, processing power for a host device 120 is greater than the processing power of the wearable device 105 connected with the other wearable device 3110. Therefore, the voice assistance level (e.g., voice interpretation library, lookups, searches, etc.) is also more expansive. One example for a headset+watch vs. a headset+phone (host device) might be that the former may show a simplified version of the result information when doing a voice search for nearby restaurants for example, whereas the latter may show a more detailed result information that includes detailed user reviews and links to the restaurant websites, etc.

FIG. 24 shows an example 3100 of multiple wireless connections between an electronic wearable device 105, another wearable device 3110 and a smart device 120, according to an embodiment. While the connection is shown occurring though the electronic wearable device 105, the connection may be performed through the host device 120 (e.g., a smart device) or even the other wearable device 3110. Such wireless connection may be via BLUETOOTH®, BLUETOOTH® low energy (BLE), Wi-Fi, or other wireless connections.

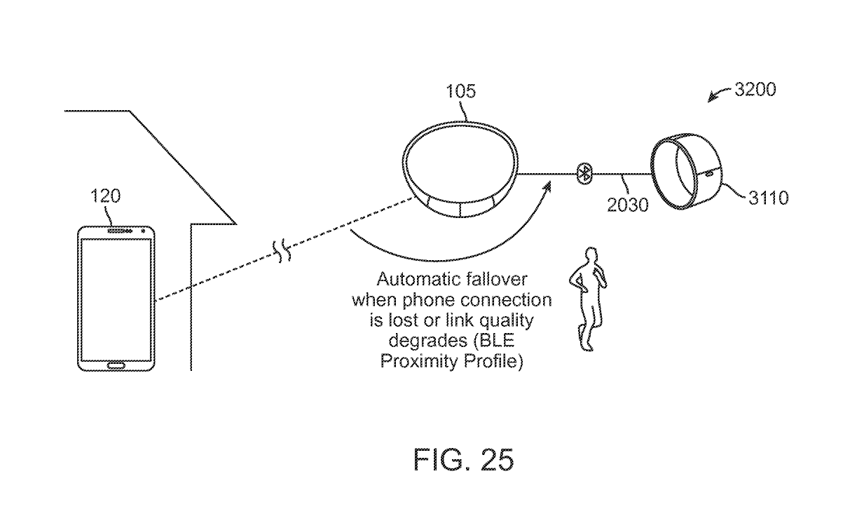

FIG. 25 shows an example 3200 of failover for connected devices, according to an embodiment. In the example 3200, as the content manager application 1110 detects a degrading signal (e.g., due to distance or interference) between smart device 120 and the electronic wearable device 105, the content manager application 1110 may initiate an automatic failover to connect the electronic wearable device 105 directly to the other wearable device 3110.

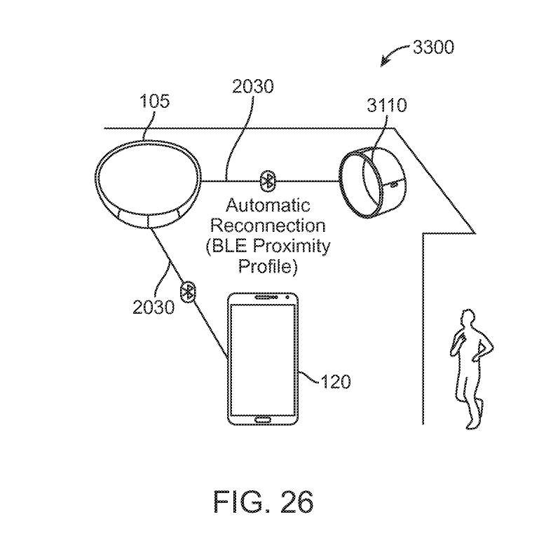

FIG. 26 shows an example 3300 of automatic reconnection for multiple electronic devices, according to an embodiment. In one example, as a better connection is detected, the content manager application 1110 may automatically restore connection between the electronic wearable device 105 and the smart device 120. The connection between the electronic wearable device 105 and the other wearable device 3110 may perform similarly, likewise with the smart device 120 and the other wearable device 3110.

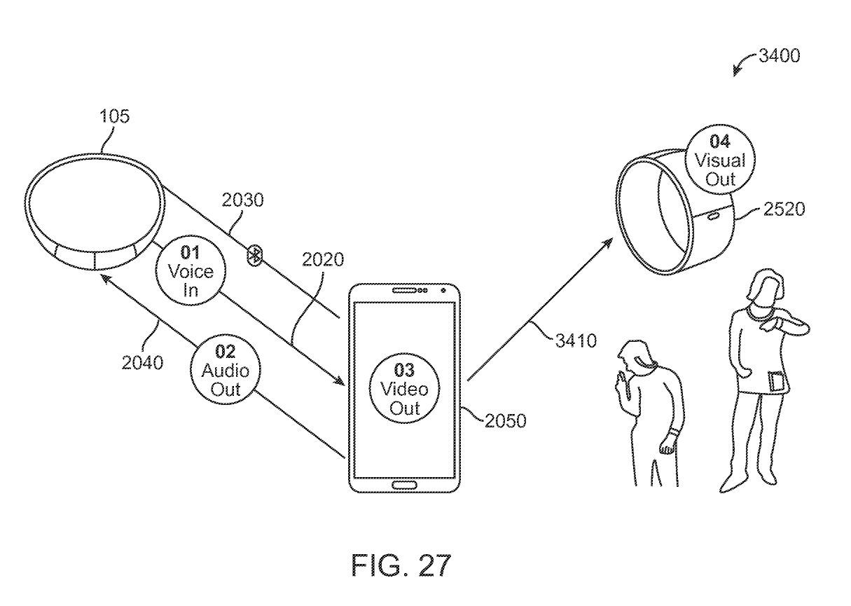

FIG. 27 shows an example 3400 of screen detection and routing visual content for multiple electronic devices, according to an embodiment. In one example, the electronic wearable device 105 is connected to the smart device 2050, which is connected to the other wearable device 2520. As shown, when a user is actively interacting with the smart device 2050 the visual output may be displayed on the smart device 2050 screen. This interaction may be detected from touchscreen input, screen detection (e.g., whether the screen is on or not), ambient light sensors, camera image capture, accelerometer, gyroscope orientation, etc. In one example, when a user is detected interacting with the other wearable device 2520, the visual output may be routed (as shown by the arrow 3410) to that device. Similar to the smart device 2050, the interaction may be detected using similar sensor mechanisms.

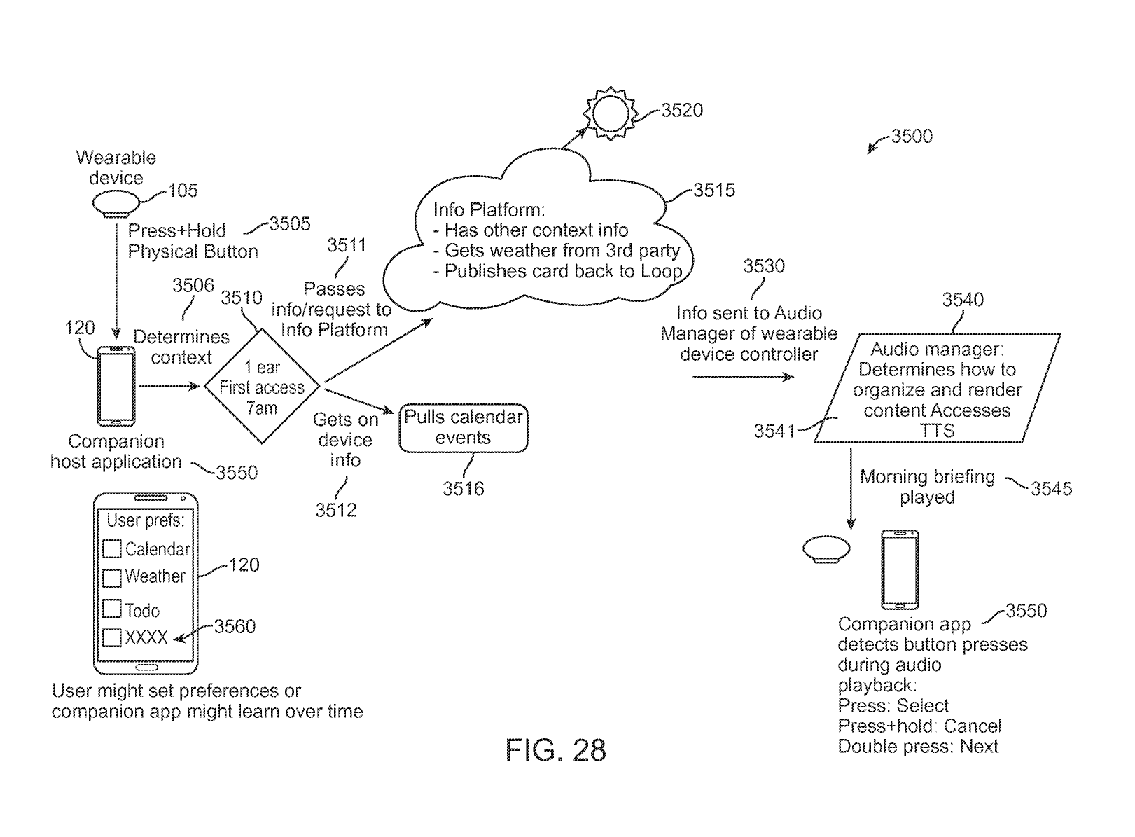

FIG. 28 shows an example process 3500 flow for providing contextual personal audio, utilizing information from a contextual information platform 3515 (e.g., cloud information platform 704, FIGS. 2A-2B) or a host device (e.g., host device 120, etc.) that communicates with a wearable device 105 via a communication link (e.g., communication link 130, FIG. 1), according to an embodiment. In one embodiment the host device includes a companion application (e.g., companion app 712, 722, FIG. 2B) that is in communication with the electronic wearable device 105. In one embodiment the state of the electronic wearable device 105 (e.g., one ear, two ear, or necklace state) or the time may be taken into account in the process.

TABLE 1
<one ear>
S: <S suggestions tone>
You have 2 meetings today:
11am 1 on 1 with Liz
5:30pm Golf with Jeff
The weather will be foggy until about 11am, then sunny with a high of
68 degrees.

In an exemplary embodiment, in the morning a user may don the electronic wearable device 105 and insert one ear bud (e.g., ear bud 11 or 13, FIG. 1). When the appropriate physical button is activated at 3505, a companion application 3550 on a host device 120 may determine context or state 3506 of the electronic wearable device 105 (e.g., the current time, registering a single ear bud is worn, first access of the day, current location, etc.) at block 3510. The companion application may send a request 3511 to a cloud information platform 3515 for contextual information (e.g., weather 3520, etc.) or gets on device information 3512 by pulling from local information 3516 contained on the device (e.g., calendar events). In one example, a user may select preferences 3560 on a host device 120 executing or running a companion application 3550 that may be learned over time. For example, if a user requests particular information repeatedly over a particular time (e.g., several days, weeks, etc.), the companion application 3550 may request information that may be provided to the electronic wearable device 105 automatically at particular times of the day (e.g., morning local news, weather, breaking news; afternoon stock reports; restaurant wait times at lunch or dinner times; sports scores at a particular time of day; etc.).

The retrieved information may be provided (e.g., sent at 3530) to the wearable device controller, which may comprise an audio manager. In block 3540 the audio manager may determine how to organize and render the content 3541 into a morning briefing. The morning briefing, such as the example shown in Table 1 above, may be played to a user at 3545. Optionally, certain physical button presses at the companion app 3550 may be used to skip messages (e.g., double press) or cancel the briefing (e.g., long press).

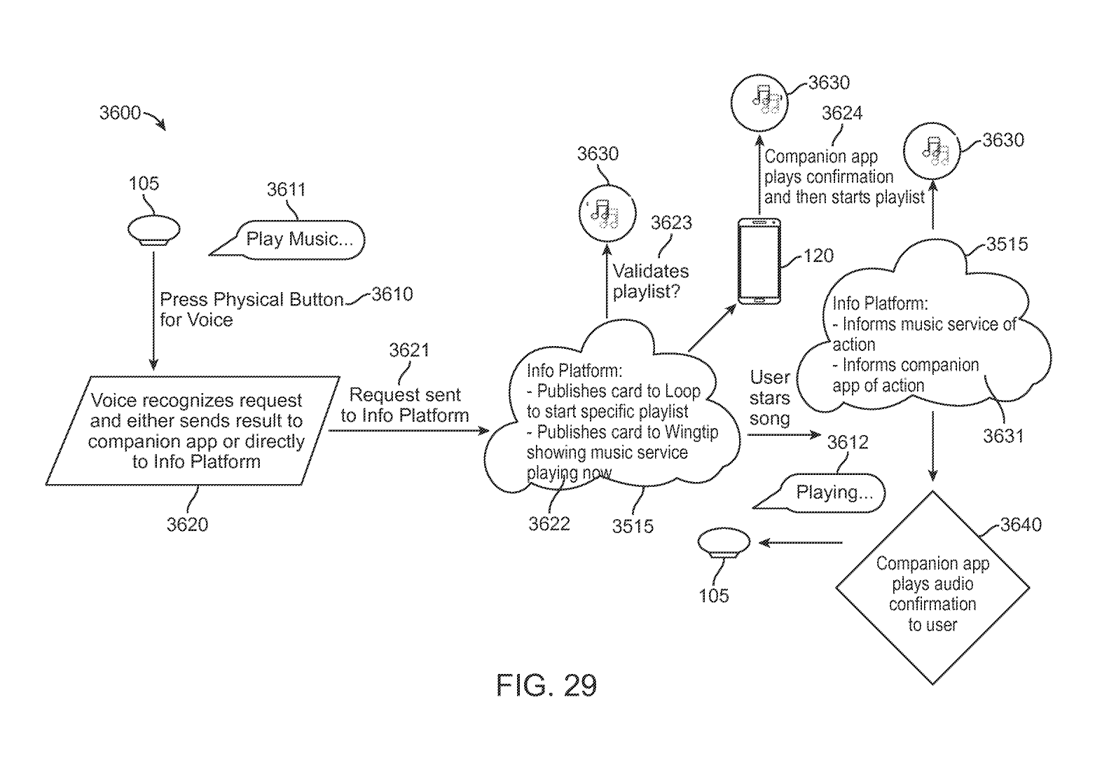

FIG. 29 shows an example process 3600 flow for providing contextual personal audio, utilizing a voice recognition interface or process of an electronic wearable device 105 detects spoken audio commands from the user, according to an embodiment. One example of contextual personal audio for a heads-up and connected context of the electronic wearable device 105 is shown in Table 2 below.

TABLE 2
<2 ears>
S: <S Voice start tone>
U: Play Spotify's Ultimate Workout mix
S: <S voice end tone>
S: Playing Ultimate Workout mix <media starts>
Start the song on watch device
<different song playing>
S: <song starred or action taken> Song starred for later
S: Do you want to compete in a run challenge?
U: Yeah
S: OK, make a left towards the Ferry building, and I'll tell you when it starts.

In one exemplary embodiment, a user may be wearing both ear buds (e.g., ear buds 111, 113, FIG. 1) of the wearable device and trigger voice commands with a physical button 3610. On a prompt, a user command 3611 may be provided, such as requesting to play music from a specific application. The request may be passed from the electronic wearable device 105 to the host device 120. At 3620 the voice command function may recognize the command and provide the request at 3621 to the companion application or directly route the request to the information platform 3515. The information platform 3515 or companion application may interact 3622 with a third party application 3630 as directed through the command (e.g., launching the application, validating the playlist 3623, etc.). Once the response is received from the application, the companion application may provide audio confirmation 3624 of the request and carry out the request (e.g., begin playing the requested playlist or song).

In an optional embodiment, another electronic wearable device, such as a smart wrist or watch electronic device, may be incorporated into the process in block 3622. As part of the request from the companion application or information platform 3515 the third party may provide information for display on the other electronic wearable device. In another optional embodiment, the user may choose to “star” a song (e.g., mark, mark as a favorite, etc.). This information may be provided to the third party application 3630 through the information platform 3515 at 3631 or through the companion application at 3640, and the audio confirmation may be provided at 3640 to the electronic wearable device 105 with audio confirmation 3612.

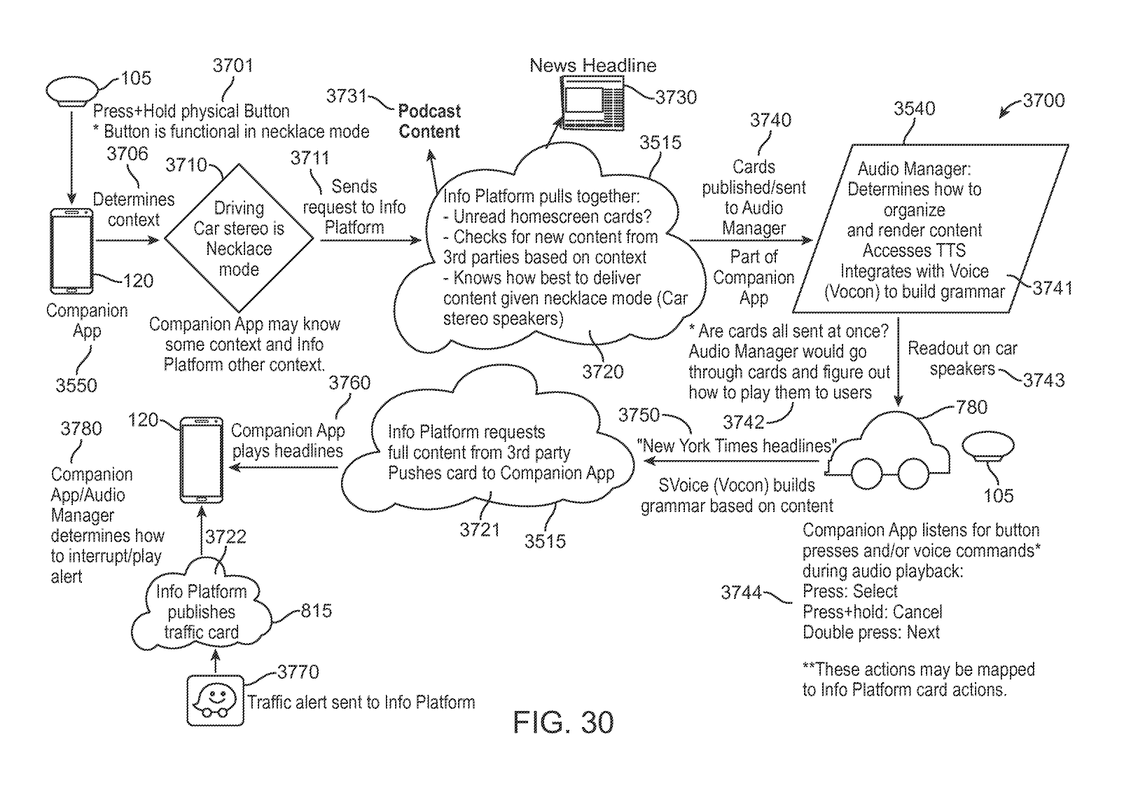

FIG. 30 shows an example process 3700 flow for providing infotainment, according to an embodiment. One example of mobile infotainment information is shown as audio interaction in Table 3 below.

TABLE 3

<necklace mode>
U: Gets into Car then press and hold SButton
S: <S suggestions tone>
S from Car speakers: Got a couple of things for
you. NPR's This American Life. New York Times
headlines ...
S: <S Voice start tone>
U: New York Times headlines
S: <S voice end tone>
S: <3 headlines play>
traffic report interrupts news S: <Alert sound>
There's a new accident on the 19th avenue exit up
ahead, best to take Lombard.

In an exemplary embodiment, the electronic wearable device 105 may be in a necklace state as the user enters an automobile/vehicle 780. Once in the vehicle 780, the electronic wearable device 105 may interface with the vehicle's infotainment system, either directly or through a host device 120. The user may activate a physical button (e.g., on the electronic wearable device 105, or in the vehicle 780) at 3701 to trigger a function. At 3706 the companion application 3550 on the host device 120 may determine relevant context at 3710 (e.g., wearable device state, user is driving, car stereo is on, time of day, etc.). The companion application 3550 may gather relevant contextual information such as news headline 3730 or podcast content 3731 locally from the host device or through requests 3711 to the cloud information platform 3515.

The information platform 3515 or the companion application 3550 may compile the information at 3720 and provide it at 3740 to the audio manager 3540, which determines how to organize and present the content at 3741 and 3742. The resulting information choices may be played through the vehicle 780 speakers at 3743. User choices may be received by the electronic wearable device 105 or the vehicle 780 microphones and a request 3750 may be made to the appropriate third party application, such as the news headlines. For example, the companion application 3550 understands button presses or voice commands at 3744. In one example, the voice recognition application builds grammar based on content and stores the information on the host device or the information platform 3515. The information platform 3515 requests the content 3721 from the third party application and may push information (e.g., graphics, displays, text, etc.) to the companion application 3550. The companion application 3550 then plays the headlines at 3760 on the host device 120.

Optionally, additional choices may be provided for the user to choose from, such as selecting the news story to listen to, etc. In an optional embodiment, the user's location may cause a traffic alert 3770 to be sent to the information platform 3515 or the companion application 3550. In one example, the alert may indicate a traffic issue 3722 (based on a received traffic card 815 published from the information platform 3515) in the vicinity and recommend a detour. The alert may interrupt 3780 the currently playing information.

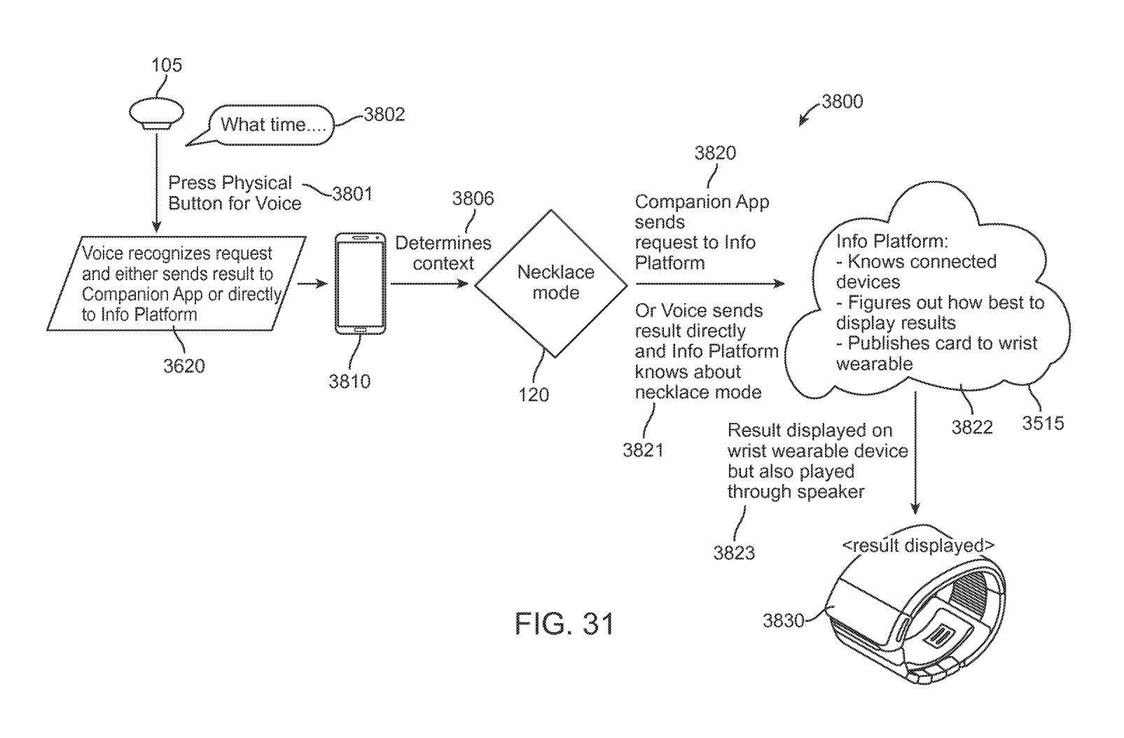

FIG. 31 shows an example process 3800 flow for providing requested information, according to an embodiment. One embodiment provides requested information, as shown by example audio interaction in Table 4 below.

TABLE 4
<necklace mode, user presses Voice Button to activate
Voice
S: <faint Voice start tone>
U: What time does the Giants
game start? S: <faint Voice end
tone>
S: <Result shows up on watch device> The Giants are playing the
Dodgers at 6:05pm.

In an exemplary embodiment, the electronic wearable device 120 may be in a necklace configuration and the user may activate the voice command function using a physical button at 3801. On an audio prompt, a command or request 3802 may be provided (e.g., what time is a specific game, directions, etc.). At block 3620 the voice command function of the wearable device may direct the request to the companion application on a host device 120 or, optionally, directly to the information platform 3515. At 3806 the companion application may determine the context (e.g., wearable device state 3810, current date, etc.) and at 3820 send a request to the information platform 2515 or check if the information is found locally on a host device 120 at 3821. In one example, at 3822 the information platform 3515 determines the best method to display results, for example to another wearable device, such as a smart wearable wrist device. At 3823 the retrieved information may be played through the electronic wearable device 105 ear buds 111 and 113 (FIG. 1) and, optionally, displayed 3830 on another wearable device at (e.g., wearable wrist device) or host device.

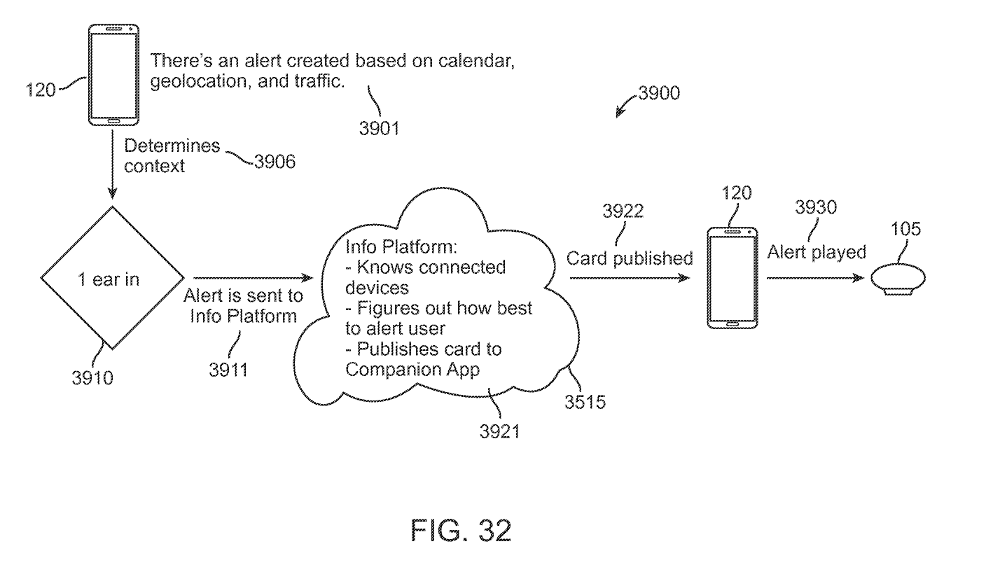

FIG. 32 shows an example process 3900 flow for providing smart alerts, according to an embodiment. One example of smart alerts is shown as audio interaction in Table 5 below.

TABLE 5
<1 ear>
S: <alert sound>
Given the traffic, leave now to get your dry cleaning on the corner and
be on time for Golf with Jeff.

In one exemplary embodiment, the companion application of the host device 120 may create an automatic proactive alert 3901, which may be based in part on calendar information, geolocation, to-do-lists, traffic or other similar factors. The companion application may determine the context or state at 3906 of the wearable device 105 (e.g., one ear bud in, necklace configuration, etc.). At 3911 the alert information 3910 may be provided to the information platform 3515, which may use the information to determine when to provide an alert to the user. For example, at 3921 calculating the user's location, traffic to the location of the tasks, subsequent meetings or appointments in the user's schedule, etc. At 3922 the information may be published as a card or other notification to the companion application of the host device 120, which in turn provides the information to be played on the wearable device 105 at 3930.

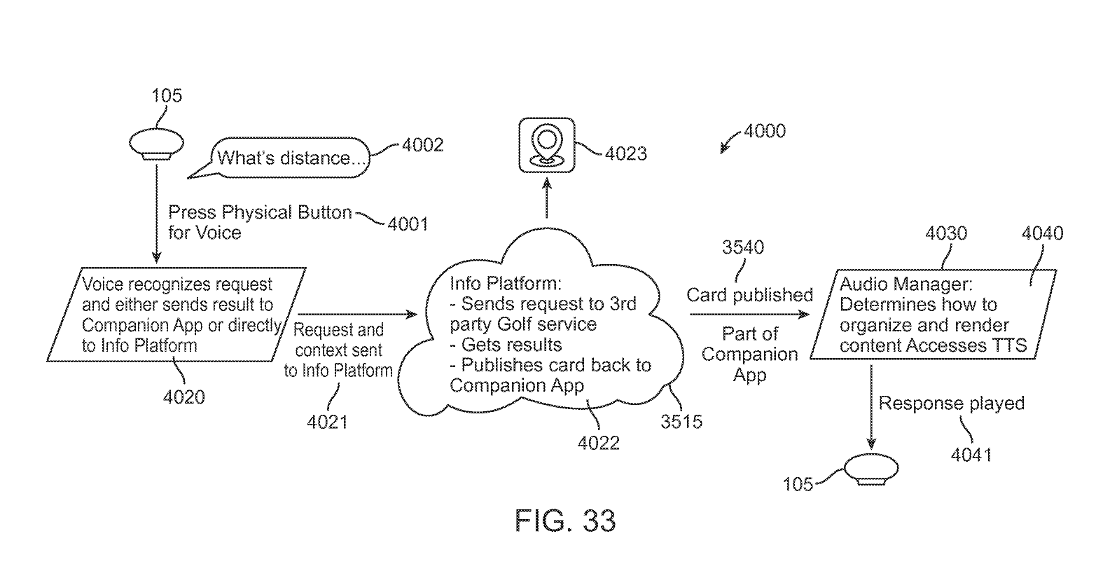

FIG. 33 shows an example process 4000 flow for providing augmented audio, according to an embodiment. One example of augmented audio is shown as audio interaction in Table 6 below.

TABLE 6
<1 ear>
U: Pressvoice
Button
S: < Voice tone>
U: What's the
distance to the hole?
S: < Voice end
tone>
S: There's 300 yards to the hole. When you use a driver you hit an
average of 240 yards.

In an exemplary embodiment for augmented audio, a user of an electronic wearable device 105 may trigger the function using a physical button at 4001 on the electronic wearable device 105, allowing the input of a command. In block 4020 the voice command function on the electronic wearable device may recognize the request 4002 and pass the command at 4021 to a companion application on a host device 120 or to an information platform 3515. The companion application may determine context (e.g., state of the wearable device, geolocation, user's characteristics/past information, etc.). The companion application may provide the information to the information platform which may query a third party application 4023 for results 4022 (e.g. using location and command to calculate distance and provide user's average distance in a sport, for example golf). At 4030 the results may be provided back to the companion application which, in turn, provides the information 4040 to the audio manager 3540 for playback at 4041 on the electronic wearable device 105.

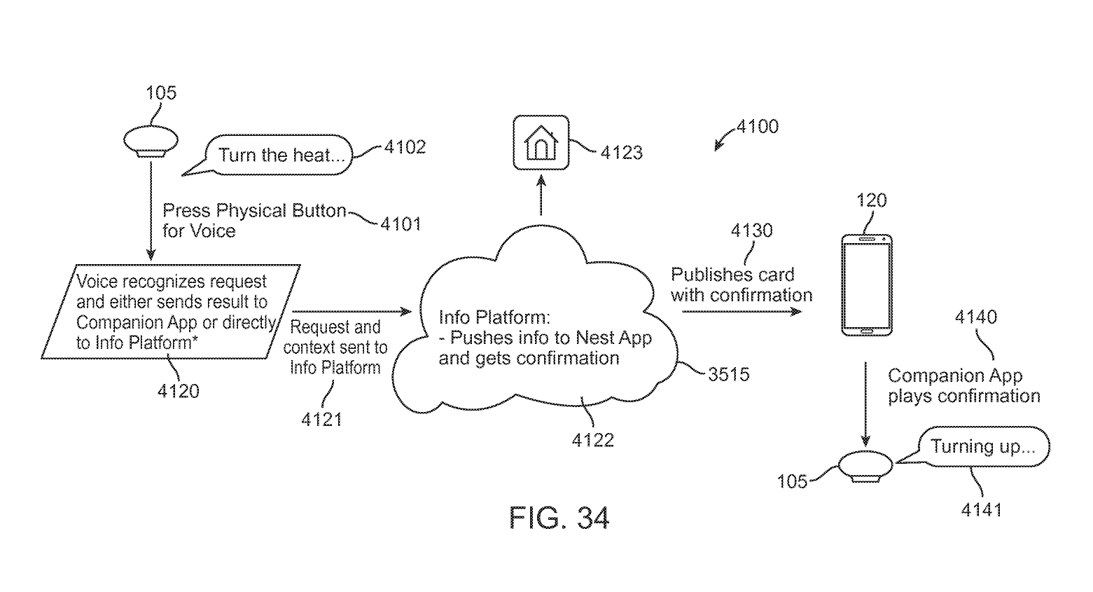

FIG. 34 shows an example process 4100 flow for providing device control, according to an embodiment. One example of audio interaction for device control is shown in Table 7 below.

TABLE 7

S: < Voice start tone>
U: Turn the heat up to
22 degrees S: < voice
end tone>
S: OK, turning the heat tip

In an exemplary embodiment, the electronic wearable device 105 may be utilized for controlling devices, appliances, etc. In one example, at 4101 the voice command may be triggered using a physical button on the electronic wearable device 105 to allow input of a voice command 4102. In block 4120 the voice command 4102 may be passed to a companion application on a host device 120 or directly to an information platform 3515. The companion application may gather contextual information (e.g., wearable device state, geolocation, etc.) and provide the additional information to the information platform 3515 along with the understood command at 4122. The information platform 3515 may interface with a third party application 4123 to carry out the command (e.g., turning up the temperature) and provide confirmation 4122 back to the companion application of the host device 120 at 4130. The confirmation may be played back at 4140 on the electronic wearable device 105 as shown in the example 4141.

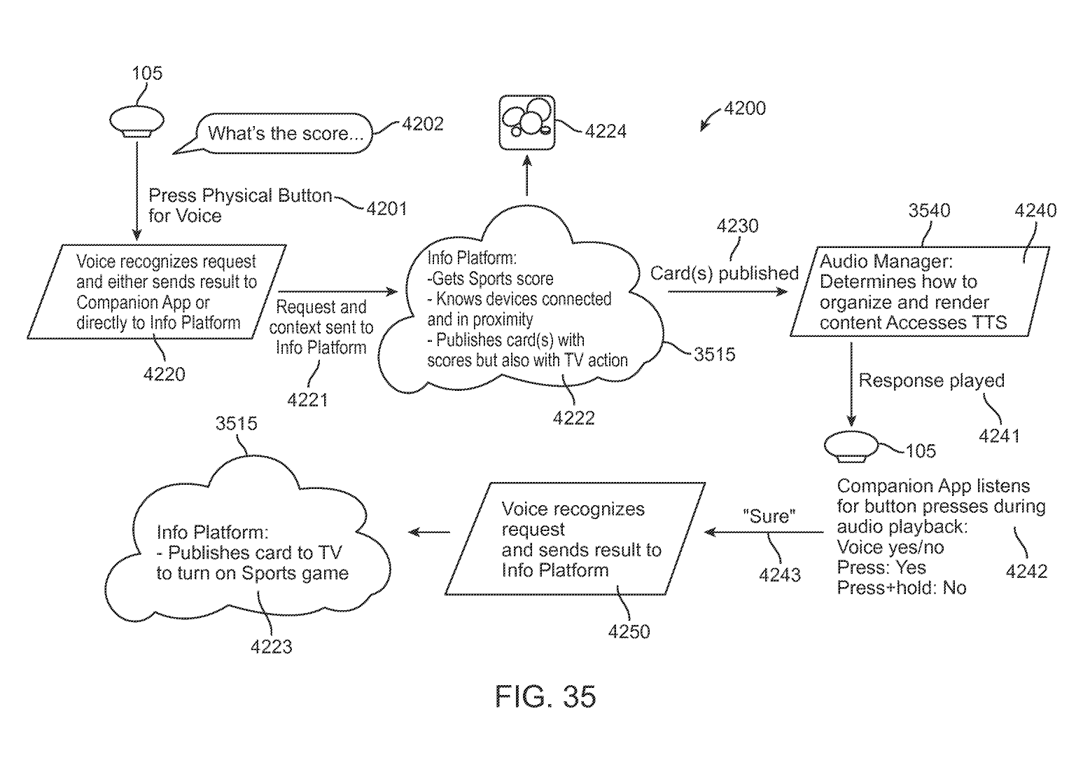

FIG. 35 shows an example process 4200 flow for providing ecosystem device integration, according to an embodiment. In one example, ecosystem device integration is shown by the example audio interaction in Table 8 below.

TABLE 8
<1 ear>
S: < Voice start tone>
U: What's the score of the
Team A game? S: < voice
end tone>
S: Team A is down 2 to nothing. Do you want to watch the game on the
living room TV?
U: Sure
Tv turns on <Team A game live broadcast sound >

In an exemplary embodiment for device integration with an ecosystem, the user may trigger a physical button at 4201 while the electronic wearable device 105 is in an appropriate configuration (e.g., one ear bud in, necklace state, etc.) The request may be in the form of a voice query 4202 (e.g., requesting a sporting event score, etc.) The voice command function of the electronic wearable device 105 may pass the request to a companion application or to an information platform 3515 at block 4220 to receive the answer. The companion application may include additional contextual information at block 4221 (e.g., geolocation, other known devices in the vicinity, etc.). The information platform 3515 obtains the information from a third party application 4224 and publishes, for example, a card 4230 and TV action 4222 (e.g., shows content, offers actions, etc.).

The resulting information may be passed back to the audio manager 3540, which determines how to organize, render content and accesses a text to speech (TTS) function at 4240 to audibly provide the response to a user along with a query if the user would like to perform an activity along the lines of the initial query (e.g., watch the specific game for which the score was requested). At 4241 the response is played on the electronic wearable device 105. At 4242 the companion application waits for button presses (or voice commands 4243 or other input) during audio playback. If an affirmative response is received at block 4250, the host device 120 or information platform 3515 may cause the appropriate device to be activated and tuned appropriately (e.g., turning on the TV and selecting the channel for the appropriate game) at 4223.

In an embodiment, how the physical buttons are activated on the device may trigger different functions. For example, a long press or a press and hold of a physical button may trigger the suggestion function which may result in flows for the embodiments shown in tables 1, 2, 3 and 6, as illustrated in FIGS. 28, 29, 30, and 33. In these embodiments, mode and context detection may be performed if appropriate without waiting for a voice command.

In another example, a single press may trigger a voice command function (e.g., from a voice recognition interface or process) which may result in flows for the embodiments shown in tables 4, 7, and 8, as illustrated in FIGS. 31, 34, and 35. In these examples, the electronic wearable device 105 may wait for voice input prior to performing mode detection. Optionally, audio output may only occur if the electronic wearable device 105 state is registered where one or more ear buds are in use.

In an embodiment, certain flows may be available based on context or a time of day. For example, the first time each day the electronic wearable device 105 is triggered using the physical button and if the time is in the morning, the morning readout, as exemplified in Table 1, may result. Subsequent triggers may perform other functions shown in Tables 2-8.

In an embodiment, the electronic wearable device 105 may perform context detection, either by itself or in conjunction with other devices in the ecosystem shown in FIG. 2A. For example, the context detection may comprise determining the mode or state of the electronic wearable device 105 (e.g., not worn, necklace state, one ear bud, both ear buds), the time of day (e.g., morning, afternoon, etc.), daily access counts, user states (e.g., walking, driving, running, stationary, etc.), location (e.g., home, work, traveling/on the go, unknown, etc.), available devices in vicinity (e.g., wearable device, smartphone, appliances, vehicle, etc.). Such context detection may be performed automatically.

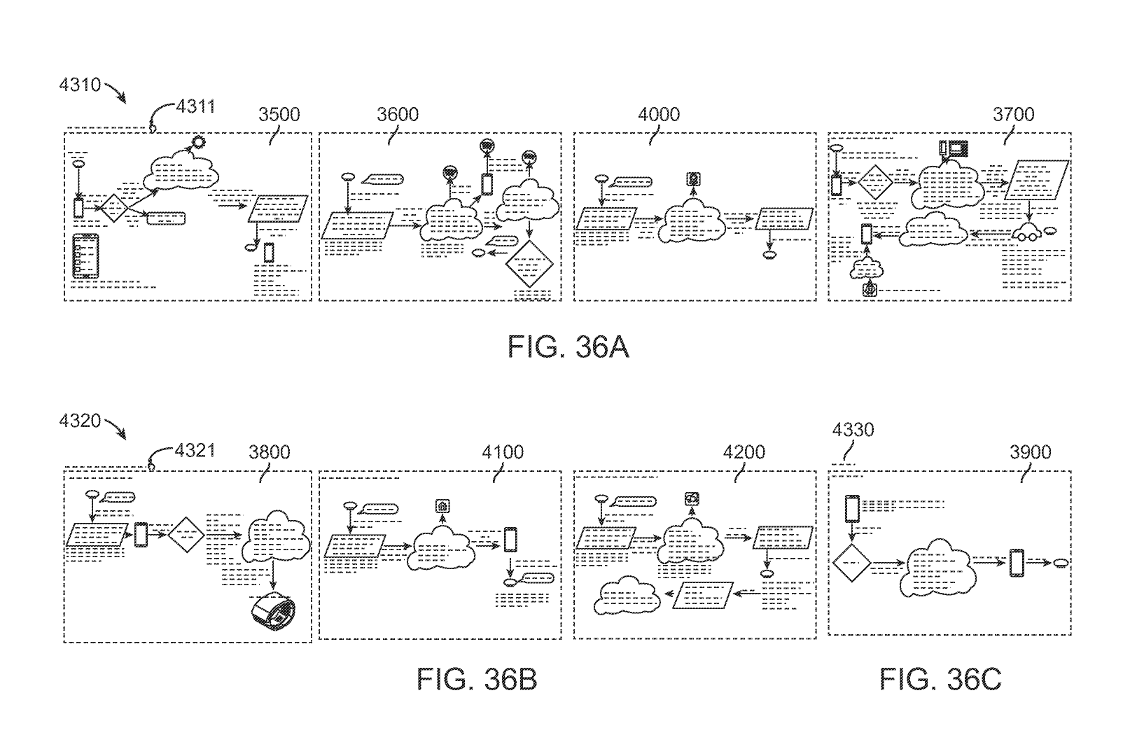

FIGS. 36A-C show example user experience (UX) classifications for a headset device, according to an embodiment. In one embodiment, UX classifications may include suggest 4310 (e.g., operated via a voice button, long press 4311), Voice 4320 (e.g., operated via the Voice button, single press 4321) and proactive 4330. In one embodiment, how the physical buttons are activated on the electronic wearable device (e.g., wearable device 105) may trigger different functions. For example, a long press or a press and hold of a physical button may trigger the suggestion function (suggest 4310), which may result in flows for processes 3500 (FIG. 28), 3600 (FIG. 29), 4000 (FIG. 33) and 3700 (FIG. 30). In another example, for Voice 4320, a single press or a press and release of a physical button may trigger the voice function (Voice 4320), which may result in flows for processes 3800 (FIG. 31), 4100 (FIG. 34), and 4200 (FIG. 35). In another example, for proactive 4330, smart alerts may be automatically pushed or pulled to a device, which may trigger process 3900 (FIG. 32). In these embodiments, mode and context detection may be performed if appropriate without waiting for a voice command.

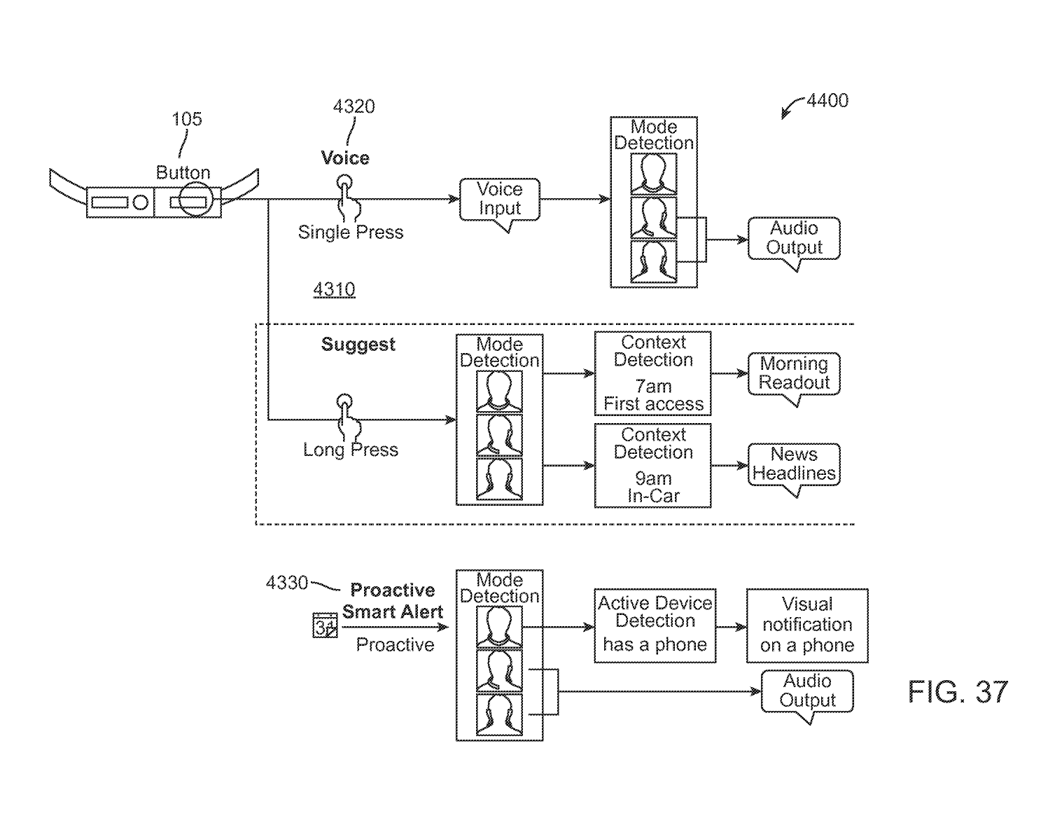

FIG. 37 shows example processes 4400 for activating UXs with an electronic wearable device (e.g., wearable device 105), according to an embodiment. In one example, a single press may trigger a voice command function (e.g., Voice 4320), which may result in flows described above for voice input, mode detection and audio output. In another example, a trigger for suggest 4310 may result in flows for mode detection, contect detection, and readouts depending on settings, as described above. In one example, for proactive (smart alert) 4330, flows for mode detection, active device detection, visual notification and audio output may result, as described above. In these examples, the electronic wearable device may wait for voice input prior to performing mode detection. In one embodiment, audio output may only occur if the electronic wearable device state is registered where one or more ear buds are in use.

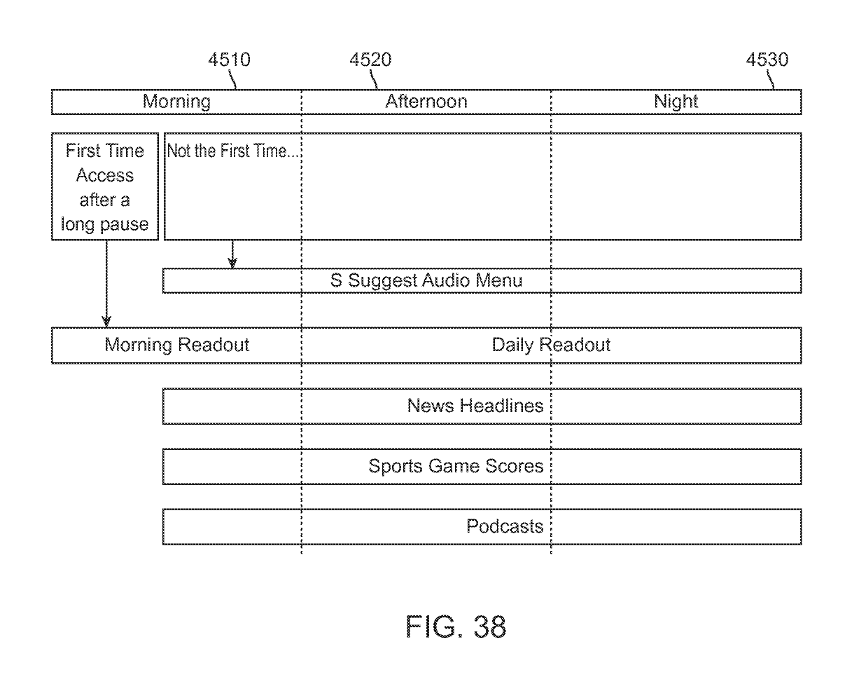

FIG. 38 shows an example architecture for contextual and personalized audio for a wearable headset device, according to an embodiment. In one embodiment, certain flows may be available based on context or a time of day. For example, the first time each day the electronic wearable device is triggered using the physical button and if the time is in the morning 4510, the morning readout may result; in the afternoon 4520, the afternoon readout may result; and at night/evening 4530, the night readout may result. Subsequent triggers may perform other functions shown in FIGS. 6, 8, 10, 13, 15, 17, and 19.

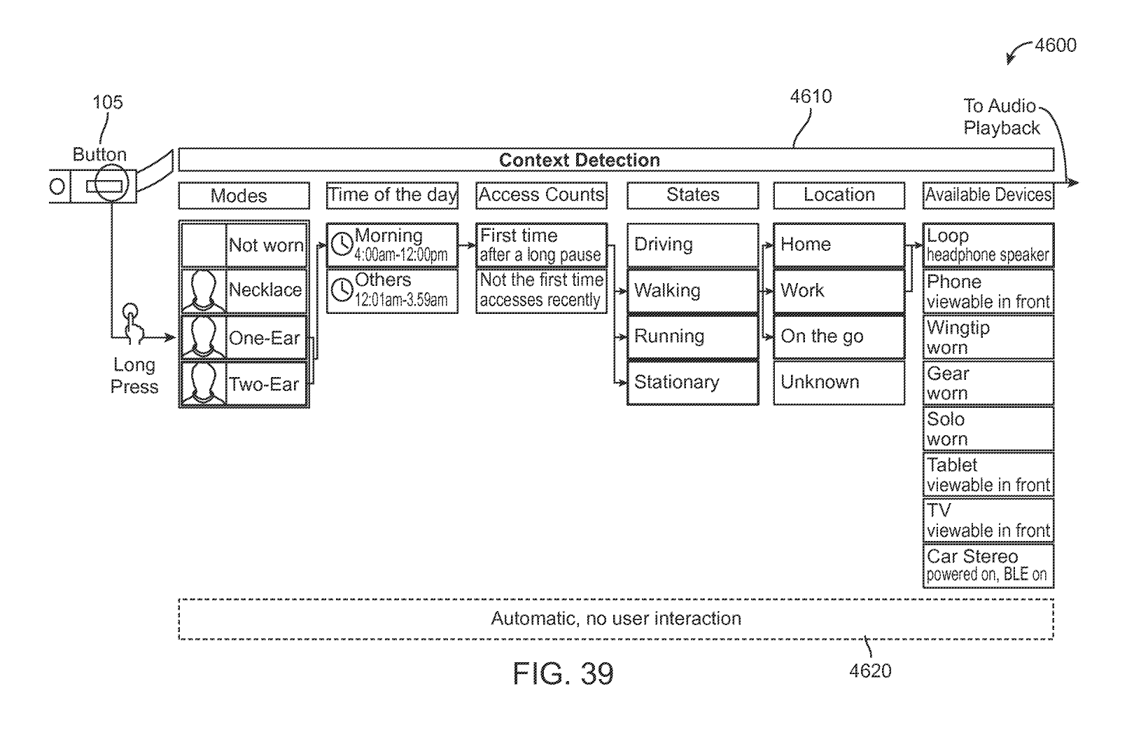

FIG. 39 shows an example flow 4600 to determine context detection 4610 (first time) for the electronic wearable device (e.g., wearable device 105), according to an embodiment. As shown, the flow 4600 determines context detection 4610 for the first time the electronic wearable device is accessed during the day, according to one embodiment. In one example, the flow 4600 may result in the audio playback for the morning readout interaction as shown. In one example, the flow 4600 occurs automatically (automatic actions 4620) once the trigger is made (e.g., button push, long press, voice command, etc.).

In one embodiment, the electronic wearable device may perform context detection 4610, either by itself or in conjunction with other devices in the ecosystem (e.g., FIG. 2B). For example, a long press of a physical button may result in automatic actions 4620 taken by either the electronic wearable device or companion application on a host device (e.g., host device 120) without requiring user interaction. In addition, these automatic actions 4620 may be transparent to a user, where the user experiences only an end result. In one example, the context detection 4610 may comprise determining the mode or state of the electronic wearable device (e.g., not worn, necklace configuration, one ear bud in-ear, both ear buds in-ear), the time of day (e.g., morning, afternoon, night, etc.), daily access counts, user states (e.g., walking, driving, running, stationary, etc.), location (e.g., home, work, traveling/on the go, unknown, etc.), available ecosystem devices in vicinity (e.g., wearable device, smartphone, appliances, vehicle, etc.).

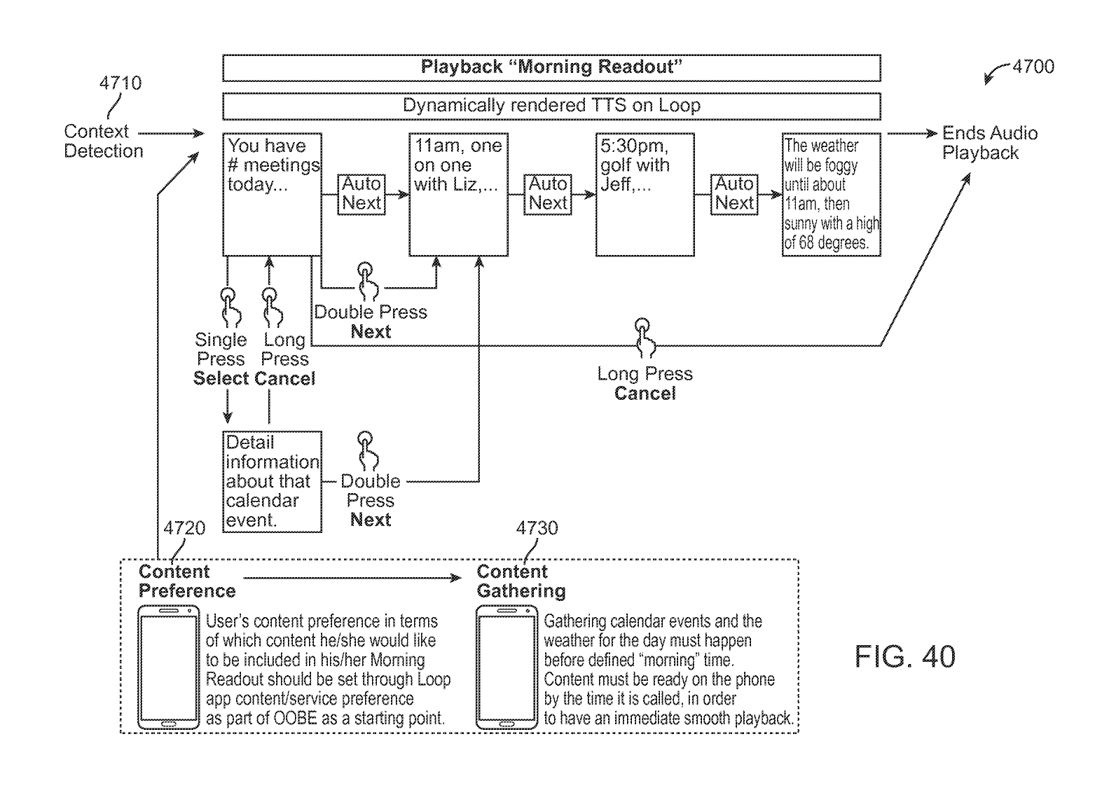

FIG. 40 shows an example flow 4700 for interactive audio playback for an electronic wearable device (e.g., wearable device 105, FIG. 1), according to an embodiment. In the example flow 4700, an exemplary interactive playback is shown where user content preferences 4720 and gathered content 4730 (such as a user's calendar) may be utilized with context detection 4710 to provide interactive audio playback. The example flow 4700 shows an exemplary morning readout where the combined context detection 4710, content preference 4720, and gathered content 4730 are dynamically rendered from text to speech on the electronic wearable device (or through the host device (e.g., host device 120)). The audio playback may indicate a specific number of certain events (e.g., meetings), which may have been gathered from a user's calendar or other source (e.g., social network, etc.). Various inputs (e.g., single press, double press, etc.) of a physical button or other registered user input (e.g., gesture, device movement, voice, etc.) may be recognized to obtain details, skip to the next event, or cancel the playback. Additionally, the morning readout may automatically progress to the next portion of the playback without user interaction to provide the audio information to a user without further input from a user.

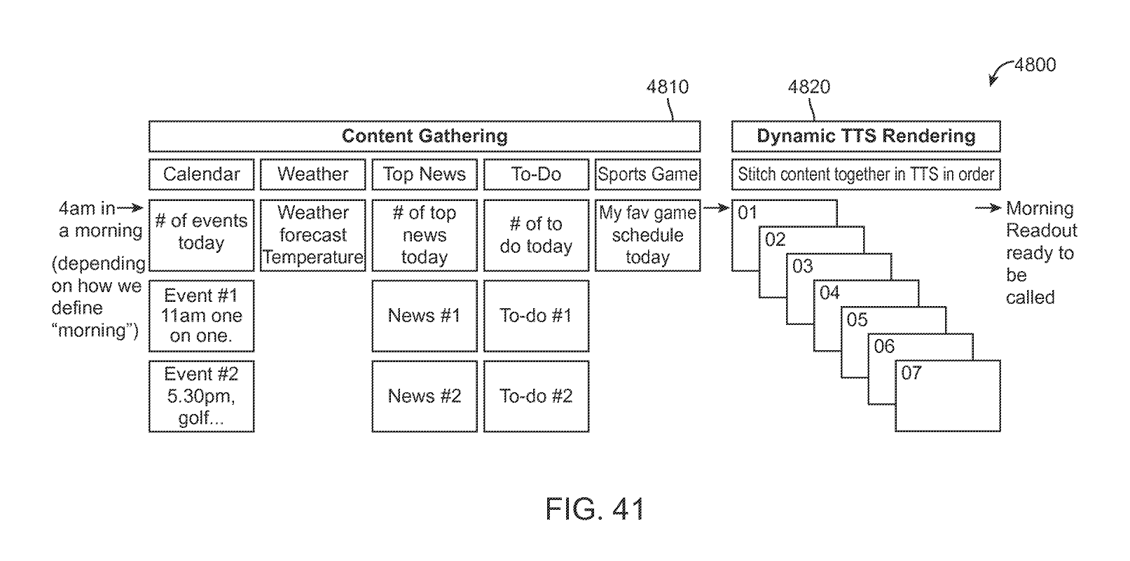

FIG. 41 shows an example process 4800 for content gathering 4810 for a morning readout, according to an embodiment. In one embodiment, at a specific time (either predetermined, dynamically adjusted, user set, etc.) the content gathering 4810 may take place over a variety of categories. Such categories may be predetermined, selectable by a user, etc. This information may be gathered from a variety of sources such as a user's calendar, local weather (based on user's GPS location, user's home location, etc.), top news stories from various or specific news stories, a user's to do list, sports information (about a user's interests, user's favorite team, etc.), or other categories.

In one embodiment, a companion application on a host device or the electronic wearable device may be configured to dynamically render the text to speech (TTS) 4820 by stitching the content together in order. This may result in a morning readout for the first activation of the electronic wearable device. In one example, the compilation of information may take place early on when a user's device may be idle or charging to preload the morning readout.

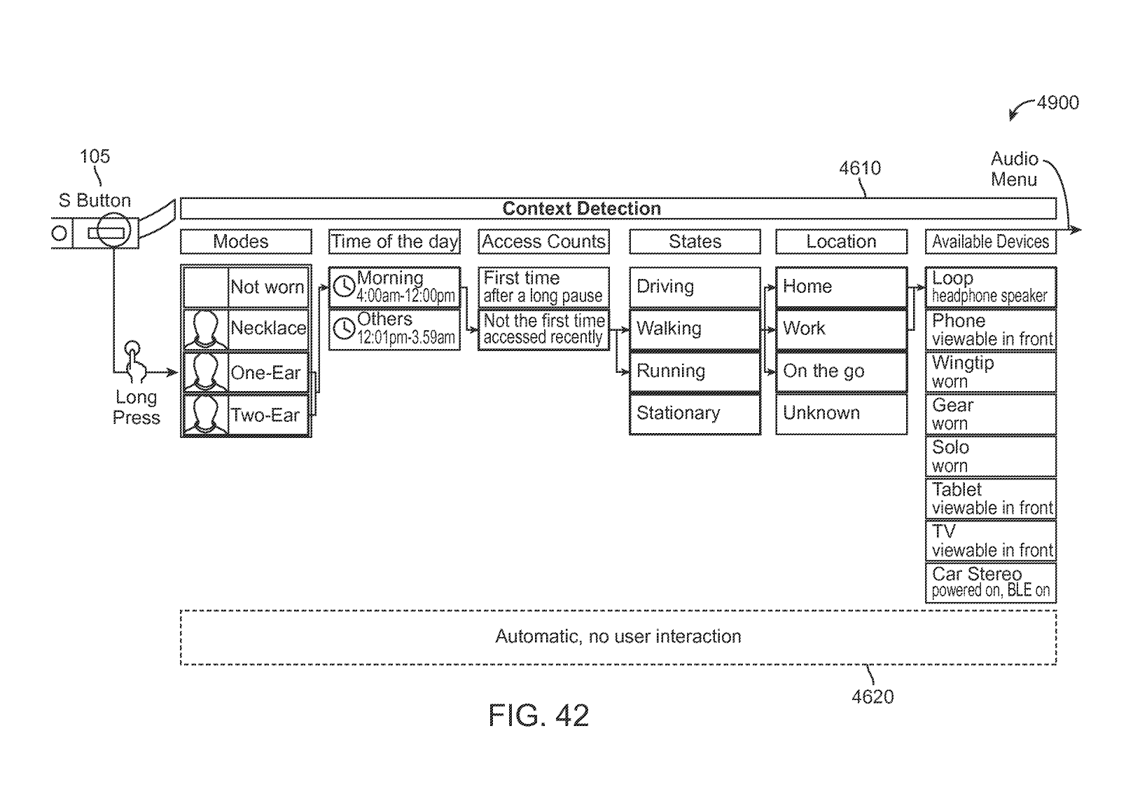

FIG. 42 shows an example process 4900 to determine context detection 4610 (not the first time) for the electronic wearable device, according to an embodiment. In one embodiment, the process 4900 is used for context detection 4610 when it is not the first time the wearable device is activated for the day. The automatic context detection 4610 may occur similarly as described in process 4900 (FIG. 42), with the differences being that the access counts category triggers the indicator that the electronic wearable device has been previously accessed. In one example, the audio output may result in an audio menu instead of a morning readout.

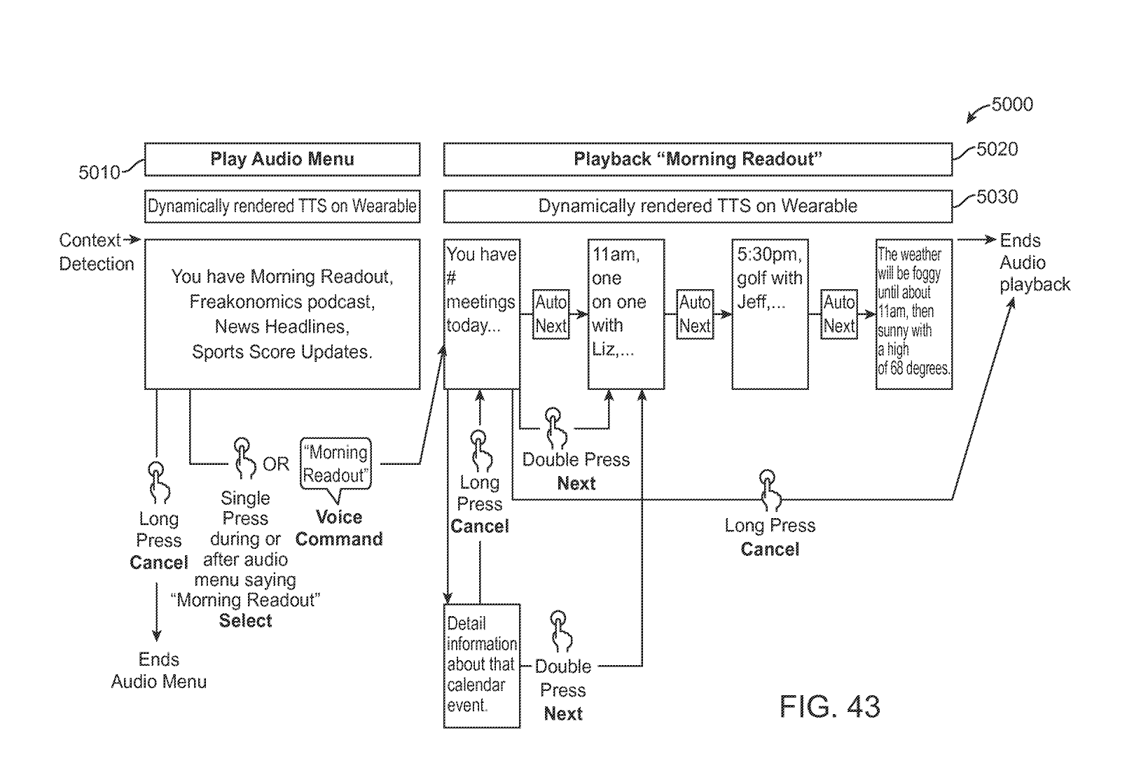

FIG. 43 shows an example process 5000 for audio menu/interactive audio playback 5010 for the electronic wearable device (e.g., wearable device 105, FIG. 1), according to an embodiment. In one embodiment, the play audio menu 5010 may be activated with user input (e.g., button press, voice command, etc.), the playback of morning readout 5020 may result in an audio output using dynamically rendered TTS 5030 on the electronic wearable device. In one example, the process 5000 shows interactive audio playback of an audio menu for user input when the wearable device has been previously accessed. The audio menu may be dynamically rendered and include options that may change based on context. The menu may take input from physical buttons, voice commands, or other input methods (e.g., through a host device, etc.) to determine which option a user desires to select. In one example, the selection of morning readout plays back the process 4700 (FIG. 40).

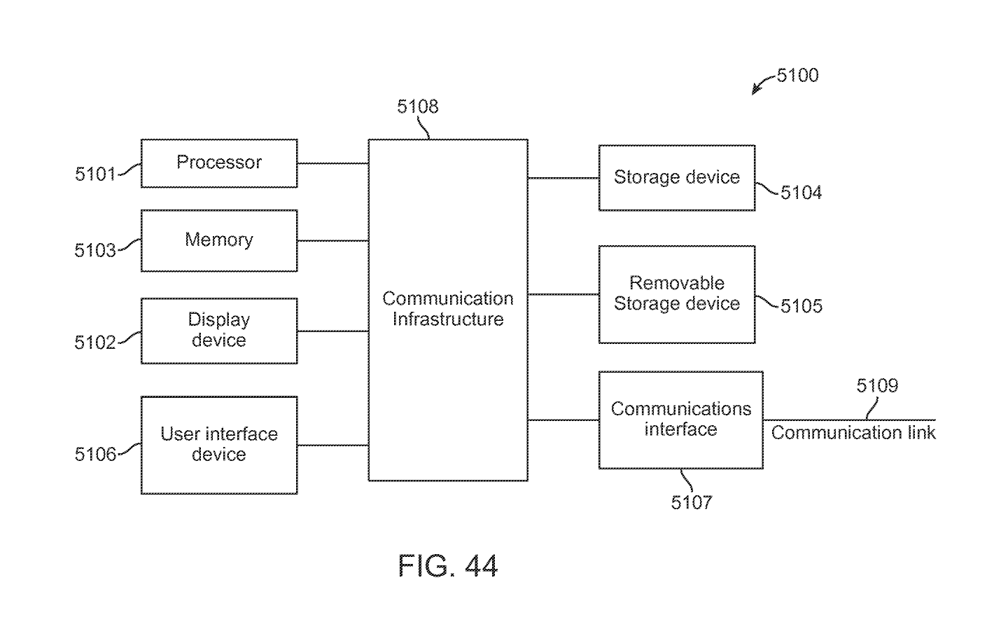

FIG. 44 is a high-level block diagram showing an information processing system comprising a computer system 5100 useful for implementing the disclosed embodiments. The computer system 5100 includes one or more processors 5101, and can further include an electronic display device 5102 (for displaying graphics, text, and other data), a main memory 5103 (e.g., random access memory (RAM)), storage device 5104 (e.g., hard disk drive), removable storage device 5105 (e.g., removable storage drive, removable memory module, a magnetic tape drive, optical disk drive, computer readable medium having stored therein computer software and/or data), user interface device 5106 (e.g., keyboard, touch screen, keypad, pointing device), and a communication interface 5107 (e.g., modem, a network interface (such as an Ethernet card), a communications port, or a PCMCIA slot and card). The communication interface 5107 allows software and data to be transferred between the computer system and external devices. The system 5100 further includes a communications infrastructure 5108 (e.g., a communications bus, cross-over bar, or network) to which the aforementioned devices/modules 5101 through 5107 are connected.

Information transferred via communications interface 5107 may be in the form of signals such as electronic, electromagnetic, optical, or other signals capable of being received by communications interface 5107, via a communication link 5109 that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

Though embodiments have been described with reference to certain versions thereof; however, other versions are possible. Therefore, the spirit and scope of the embodiments should not be limited to the description of the preferred versions contained herein.

What is claimed is:

1. A method for providing a notification on a wearable audio device comprising:
detecting a physical configuration of the wearable audio device, wherein the physical configuration is determined using information provided by one or more sensors on the wearable audio device; and
providing at least one notification routed from a mobile device which is connected with the wearable audio device in a manner corresponding to the determined physical configuration.

2. The method of claim 1, wherein the physical configuration is determined by the sensors sensing positions of one or more earpieces of the wearable audio device.

3. The method of claim 1, wherein the physical configuration is a manipulation of the shape of the wearable audio device.

4. The method of claim 1, further comprising:
managing intake of notification information provided by one or more services.

5. The method of claim 4, wherein the managing comprises:
generating a list of the one or more services;
generating one or more notifications for the one or more services; and
receiving priority classification for the one or more services.

6. The method of claim 1, further comprising:
wirelessly connecting the wearable audio device with another wearable device.

7. The method of claim 6, wherein the at least one notification is routed to a device that is a current primary focus of use based on the determined physical configuration and monitored status of connected devices.

8. The method of claim 7, wherein the at least one notification is selectively routed to the device that is the current primary focus of use based on a predetermined priority classification.

9. The method of claim 7, wherein the monitored status is determined from information received from sensors of the connected devices.

10. The method of claim 1, further comprising:
performing an audio playback upon request, wherein the playback includes retrieved content based on preselected content categories for preset time intervals.

11. The method of claim 1, further comprising:
receiving and interpreting subjective commands from the wearable audio device by querying multiple third party sources and selecting an appropriate action on one of the wearable audio device, the mobile device and a wearable electronic device.

12. The method of claim 11, further comprising:
coordinating interaction between the wearable audio device, the mobile device, and the wearable electronic device.

13. The method of claim 12, further comprising:
executing an application or function by the wearable audio device, wherein the application or function provides contextual information based on one or more of user context with the wearable audio device, and information from one or more of the mobile device, a server device and a cloud-based service.

14. The method of claim 13, further comprising:
executing a companion application by the mobile device, wherein the companion application enables selection of services that comprise personalized and contextual audio information provided to the wearable audio device.

15. The method of claim 14, wherein the companion application generates a list of applications using notifications.

16. The method of claim 1, further comprising:
performing context detection directly and in conjunction with other connected devices by the wearable audio device.

17. The method of claim 1, wherein the wearable audio device connects with other devices in an ecosystem that comprises one or more of: a smart phone, a tablet, another wearable device, a smart TV, an appliance, and a vehicle.

18. A system comprising:
a host device including a manager that is configured for providing at least one notification to a connected wearable audio device in a manner corresponding to a detected physical configuration of the wearable device.

19. The system of claim 18, wherein the physical configuration is determined by sensors sensing positions of one or more earpieces of the wearable audio device.

20. The system of claim 18, wherein the manager is further configured for:
managing intake of notification information provided by one or more services based on generating a list of the one or more services, generating one or more notifications for the one or more services, and receiving priority classification for the one or more services.

21. The system of claim 18, wherein the wearable audio device is wirelessly connected with another wearable device, and the at least one notification is routed by the manager to a device that is a current primary focus of use based on the determined physical configuration and monitored status of connected devices.

22. The system of claim 21, wherein the manager is further configured for:
coordinating interaction between the wearable audio device, the mobile device, and the wearable electronic device, executing an application or function by the wearable audio device, wherein the application or function provides contextual information based on one or more of user context with the wearable audio device, and information from one or more of the mobile device, a server device and a cloud-based service, and executing a companion application by the mobile device, wherein the companion application enables selection of services that comprise personalized and contextual audio information provided to the wearable audio device, and the companion application controls one or more other electronic devices and applications using one of voice commands, touch sensed commands, pressure sensed commands, and motion sensed commands.

23. The system of claim 18, wherein the wearable audio device is configured for performing context detection directly and in conjunction with other connected devices, and the wearable audio device connects with other devices in an ecosystem that comprises one or more of: a smart phone, a tablet, another wearable device, a smart TV, an appliance, and a vehicle.

24. A non-transitory computer-readable medium having instructions which when executed on a computer perform a method comprising:
detecting a physical configuration of a wearable audio device, wherein the physical configuration is determined using information provided by one or more sensors on the wearable audio device; and
providing at least one notification routed from a mobile device which is connected with the wearable audio device in a manner corresponding to the determined physical configuration.

25. The medium of claim 24, wherein the physical configuration is determined by the sensors sensing positions of one or more earpieces of the wearable audio device.

26. The medium of claim 24, further comprising:
managing intake of notification information provided by one or more services, wherein the managing comprises:
generating a list of the one or more services;
generating one or more notifications for the one or more services; and
receiving priority classification for the one or more services.

27. The medium of claim 24, further comprising:
wirelessly connecting the wearable audio device with another wearable device, wherein the at least one notification is routed to a device that is a current primary focus of use based on the determined physical configuration and monitored status of connected devices.

28. The medium of claim 27, further comprising:
coordinating interaction between the wearable audio device, the mobile device, and the wearable electronic device;
executing an application or function by the wearable audio device, wherein the application or function provides contextual information based on one or more of user context with the wearable audio device, and information from one or more of the mobile device, a server device and a cloud-based service; and
executing a companion application by the mobile device, wherein the companion application enables selection of services that comprise personalized and contextual audio information provided to the wearable audio device,
wherein the companion application controls one or more other electronic devices and applications using one of voice commands, touch sensed commands, pressure sensed commands, and motion sensed commands.

29. The medium of claim 24, further comprising:
performing context detection directly and in conjunction with other connected devices by the wearable audio device.

30. The medium of claim 24, further comprising:
connecting the wearable audio device with other devices in an ecosystem that comprises one or more of: a smart phone, a tablet, another wearable device, a smart TV, an appliance, and a vehicle.
